(19) United States
(12) Patent Application Publication
(10) Pub. No.: US 2025/0294393 A1
(43) Pub. Date: Sep. 18, 2025

(54) TECHNIQUES TO FACILITATE EXPLOITING INDICATION REDUNDANCY BETWEEN TRANSMISSION RECEPTION POINT SELECTION AND SPATIAL DOMAIN BASIS SELECTION

(71) Applicant: QUALCOMM Incorporated, San Diego, CA (US)

(72) Inventors: Jing DAI, Beijing (CN); Liangming WU, Beijing (CN); Chenxi HAO, Beijing (CN); Chao WEI, Beijing (CN); Wei XI, Beijing (CN); Min HUANG, Beijing (CN); Hao XU, Beijing (CN)

(21) Appl. No.: 18/861,185

(22) PCT Filed: Feb. 17, 2023
(86) PCT No.: PCT/CN2023/076796

§ 371 Date: Oct. 28, 2024

(30) Foreign Application Priority Data
Jun. 17, 2022 (WO) PCT/CN2022/099353

(51) Int. Cl. H04W 24/10; H04L 5/00

(52) U.S. Cl. CPC H04W 24/10; H04L 5/0035

(57) ABSTRACT

Apparatus, methods, and computer-readable media for facilitating exploiting indication redundancy between transmission reception point selection and spatial domain basis selection are disclosed herein. An example method for wireless communication at a user equipment includes receiving a configuration configuring a channel state information (CSI) report associated with coherent joint transmission (CJT) with multiple transmission reception points (TRPs). The example method also includes receiving a CSI reference signal (CSI-RS). The example method also includes transmitting the CSI report based on measurements performed on the CSI-RS, the CSI report based on the configuration, the CSI report indicating a beam selection of one or more selected beams of the multiple TRPs, the beam selection indicating a total number of selected beams, and the total number of selected beams is across all TRPs of the multiple TRPs and is irrespective of selected TRPs indicated in the CSI report.

### CROSS REFERENCE TO RELATED APPLICATION

This application claims the benefit of and priority to PCT Application Serial No. PCT/CN2022/099353, entitled “TECHNIQUES TO FACILITATE EXPLOITING INDICATION REDUNDANCY BETWEEN TRANSMISSION RECEPTION POINT SELECTION AND SPATIAL DOMAIN BASIS SELECTION” and filed on Jun. 17, 2022, which is expressly incorporated by reference herein in its entirety.

### TECHNICAL FIELD

The present disclosure relates generally to communication systems, and more particularly, to wireless communications utilizing coherent joint transmission (CJT) from multiple transmission reception points (TRPs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication. An apparatus may include a user equipment (UE). The example apparatus may receive a configuration configuring a channel state information (CSI) report associated with coherent joint transmission (CJT) with multiple transmission reception points (TRPs). The example apparatus receive a CSI-RS. Additionally, the example apparatus may transmit the CSI report based on measurements performed on the CSI-RS, the CSI report based on the configuration, the CSI report indicating a beam selection of one or more selected beams of the multiple TRPs, the beam selection indicating a total number of selected beams, and the total number of selected beams is across all TRPs of the multiple TRPs and is irrespective of selected TRPs indicated in the CSI report.

In another aspect of the disclosure, a method, a computer-readable medium, and an apparatus are provided for wireless communication. An apparatus may include a network entity, such as a base station. The example apparatus may transmit a configuration configuring a CSI report associated with multiple TRPs. The example apparatus may also transmit a CSI-RS. Additionally, the example apparatus may receive the CSI report based on the configuration and the CSI-RS, the CSI report indicating a beam selection of one or more selected beams of the multiple TRPs, the beam selection indicating a total number of selected beams, and the total number of selected beams is across all TRPs of the multiple TRPs and is irrespective of selected TRPs indicated in the CSI report. The example apparatus may also transmit data in a CJT at least partly based on the CSI report.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating characteristics of non-coherent joint transmission (NCJT), in accordance with various aspects of the present disclosure.

FIG. 4B is a diagram illustrating characteristics of a CJT, in accordance with various aspects of the present disclosure.

FIG. 5 is a diagram illustrating components of a precoder in some aspects of wireless communication, in accordance with various aspects of the present disclosure.

FIG. 6 is a diagram illustrating a set of pre-coder components used in some aspects of CJT, in accordance with various aspects of the present disclosure.

FIG. 7 is a diagram illustrating an example of a two part CSI, in accordance with various aspects of the present disclosure.

FIG. 8 is a diagram illustrating an example of K transmission hypotheses associated with a CSI report, in accordance with various aspects of the present disclosure.

FIG. 9 is an example communication flow between a network entity and a UE, in accordance with the teachings disclosed herein.

FIG. 10 is a diagram illustrating an example of a first CSI part and a second CSI part that may be included in a CSI report, in accordance with the teachings disclosed herein.

FIG. 11 is a diagram illustrating another example of a first CSI part and a second CSI part that may be included in a CSI report, in accordance with the teachings disclosed herein.

FIG. 12 is a diagram illustrating another example of a first CSI part and a second CSI part that may be included in a CSI report, in accordance with the teachings disclosed herein.

FIG. 13 is a diagram illustrating another example of a first CSI part and a second CSI part that may be included in a CSI report, in accordance with the teachings disclosed herein.

FIG. 14 is a diagram illustrating a table of different CSI overhead based on different CSI reports, in accordance with the teachings disclosed herein.

FIG. 15 is a flowchart of a method of wireless communication at a UE, in accordance with the teachings disclosed herein.

FIG. 16 is a diagram illustrating an example of a hardware implementation for an example apparatus and/or network entity.

FIG. 17 is a flowchart of a method of wireless communication at a network entity, in accordance with the teachings disclosed herein.

FIG. 18 is a diagram illustrating an example of a hardware implementation for an example network entity.

### DETAILED DESCRIPTION

In some aspects of wireless communication, joint transmission across multiple TRPs may be enabled. The joint transmission may be a non-coherent JT (NCJT) in which data (layers) may be precoded separately on different TRPs, or may be a CJT in which a same layer may be transmitted via multiple TRPs with phase coherence.

In some aspects, the coherence of CJT refers to a phase coherence between TRPs that may be transmitting a same layer as opposed to NCJT in which each layer is transmitted via a single TRP and phase coherence between the TRPs may not provide additional benefits. In some aspects of wireless communication, CJT may be extended to up to 4 TRPs, for example, in a low frequency band such as FR1, based on a type-II codebook. In some aspects, providing additional TRPs for CJT may effectively increase an antenna size for transmitting the low frequency transmission.

In some examples in which multiple TRPs are supported, the indication of a TRP selection and the indication of a spatial domain (SD) basis selection may be coupled. For example, a beam may be indicated based on an antenna port of a TRP. Thus, by indicating a particular beam, the corresponding TRP may also be indicated as the TRP may be an intermediate dimension or level of indicating the particular beam.

Aspects disclosed herein provide techniques for utilizing the relationship between TRP selection and SD basis selection to improve communication performance, for example, by reducing overhead associated with indicating the TRP selection and the SD basis selection. In some examples, the number of selected SD bases (e.g., L beams) may be configured to the UE and may represent the total number of selected SD bases across all TRPs, and may be independent of the N TRPs indicated in the CSI report.

Particular aspects of the subject matter described in this disclosure can be implemented to realize one or more of the following potential advantages. In some examples, by indicating a TRP selection and an SD basis selection via the CSI part 1 and the CSI part 2, the described techniques can be used to reduce overhead associated with indicating the TRP selection and the SD basis selection for CJT.

Although the following description provides examples directed to 5G NR, the concepts described herein may be applicable to other similar areas, such as 6G, 5G-advanced, LTE, LTE-A, CDMA, GSM, and/or other wireless technologies, utilizing CJT from multiple TRPs.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

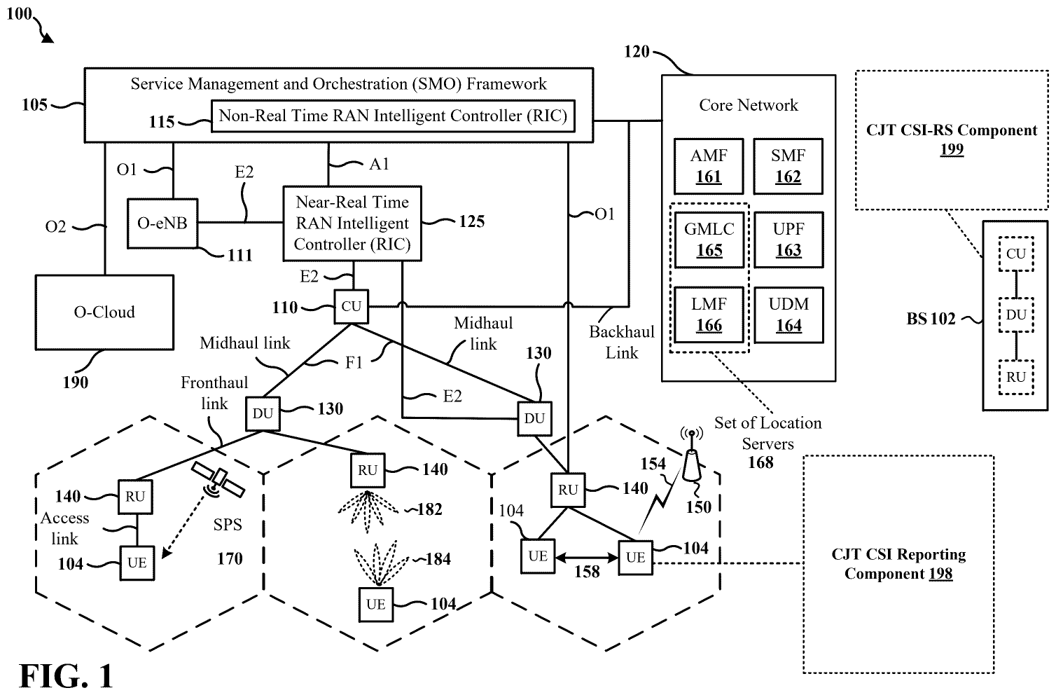

FIG. 1 is a diagram 100 illustrating an example of a wireless communications system and an access network. The illustrated wireless communications system includes a disaggregated base station architecture. The disaggregated base station architecture may include one or more CUs (e.g., a CU 110) that can communicate directly with a core network 120 via a backhaul link, or indirectly with the core network 120 through one or more disaggregated base station units (such as a Near-Real Time (Near-RT) RAN Intelligent Controller (RIC) (e.g., a Near-RT RIC 125) via an E2 link, or a Non-Real Time (Non-RT) RIC 115 associated with a Service Management and Orchestration (SMO) Framework (e.g., an SMO Framework 105), or both). A CU 110 may communicate with one or more DUs (e.g., a DU 130) via respective midhaul links, such as an F1 interface. The DU 130 may communicate with one or more RUs (e.g., an RU 140) via respective fronthaul links. The RU 140 may communicate with respective UEs (e.g., a UE 104) via one or more radio frequency (RF) access links. In some implementations, the UE 104 may be simultaneously served by multiple RUs.

Each of the units, i.e., the CUS (e.g., a CU 110), the DUs (e.g., a DU 130), the RUs (e.g., an RU 140), as well as the Near-RT RICs (e.g., the Near-RT RIC 125), the Non-RT RICs (e.g., the Non-RT RIC 115), and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU 140 can be implemented to handle over the air (OTA) communication with one or more UEs (e.g., the UE 104). In some implementations, real-time and non-real-time aspects of control and user plane communication with the RU 140 can be controlled by a corresponding DU. In some scenarios, this configuration can enable the DU(s) and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs (e.g., the RU 140) and the UEs (e.g., the UE 104) may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UE 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication (e.g., a D2D communication link 158). The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with a UE 104 (also referred to as Wi-Fi stations (STAs)) via communication link 154, e.g., in a 5 GHz unlicensed frequency spectrum or the like. When communicating in an unlicensed frequency spectrum, the UE 104/Wi-Fi AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) (e.g., an AMF 161), a Session Management Function (SMF) (e.g., an SMF 162), a User Plane Function (UPF) (e.g., a UPF 163), a Unified Data Management (UDM) (e.g., a UDM 164), one or more location servers 168, and other functional entities. The AMF 161 is the control node that processes the signaling between the UE 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) (e.g., a GMLC 165) and a Location Management Function (LMF) (e.g., an LMF 166). However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a device in communication with a network entity, such as a UE 104 in communication with a base station 102 or a component of a base station (e.g., a CU 110, a DU 130, and/or an RU 140), may be configured to manage one or more aspects of wireless communication. For example, the UE 104 may have a CJT CSI reporting component 198 that may be configured to facilitate exploiting indication redundancy between TRP selection and SD basis selection.

In certain aspects, the CJT CSI reporting component 198 may be configured to receive a configuration configuring a CSI report associated with CJT with multiple TRPs. The example CJT CSI reporting component 198 may also be configured to receive a CSI-RS. Additionally, the example CJT CSI reporting component 198 may be configured to transmit the CSI report based on measurements performed on the CSI-RS, the CSI report being based on the configuration, the CSI report indicating a beam selection of one or more selected beams of the multiple TRPs, the beam selection indicating a total number of selected beams, and the total number of selected beams being across all TRPs of the multiple TRPs and being irrespective of selected TRPs indicated in the CSI report.

In another configuration, a network entity, such as a base station 102 or a component of a base station (e.g., a CU 110, a DU 130, and/or an RU 140), may be configured to manage or more aspects of wireless communication. For example, the base station 102 may have a CJT CSI-RS component 199 that may be configured to facilitate exploiting indication redundancy between TRP selection and SD basis selection.

In certain aspects, the CJT CSI-RS component 199 may be configured to transmit a configuration configuring a CSI report associated with multiple TRPs. The example CJT CSI-RS component 199 may also be configured to transmit a CSI-RS. Additionally, the example CJT CSI-RS component 199 may be configured to receive the CSI report based on the configuration and the CSI-RS, the CSI report indicating a beam selection of one or more selected beams of the multiple TRPs, the beam selection indicating a total number of selected beams, and the total number of selected beams is across all TRPs of the multiple TRPs and is irrespective of selected TRPs indicated in the CSI report. The example CJT CSI-RS component 199 may also be configured to transmit data in a CJT at least partly based on the CSI report

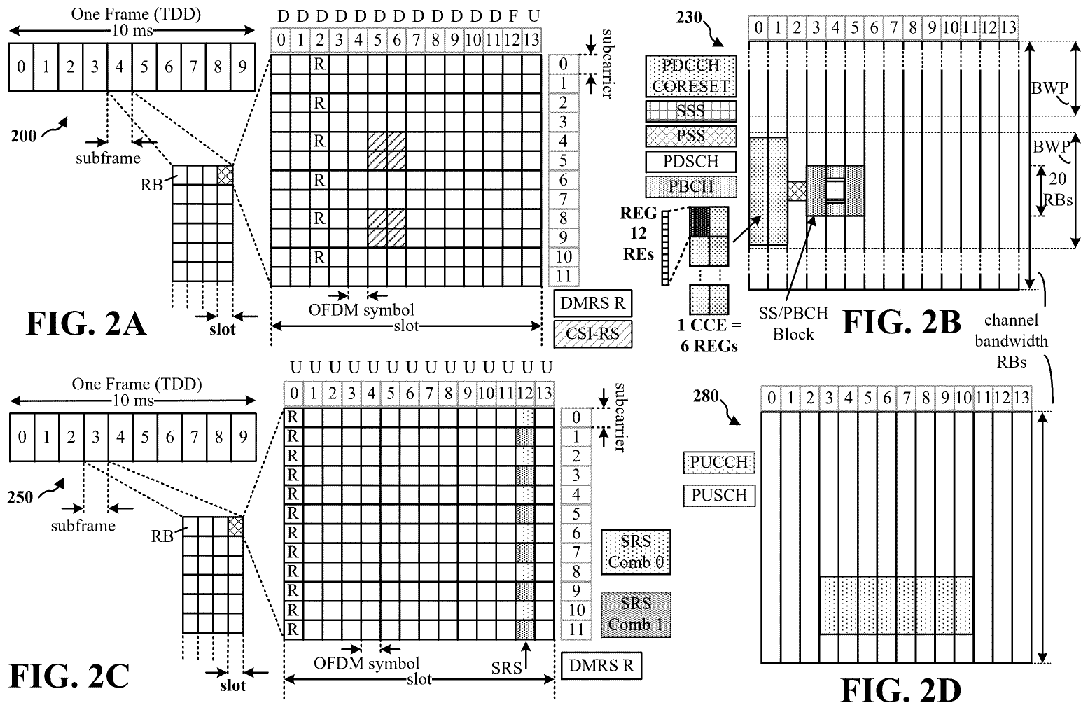

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with l/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. As shown in Table 1, the subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

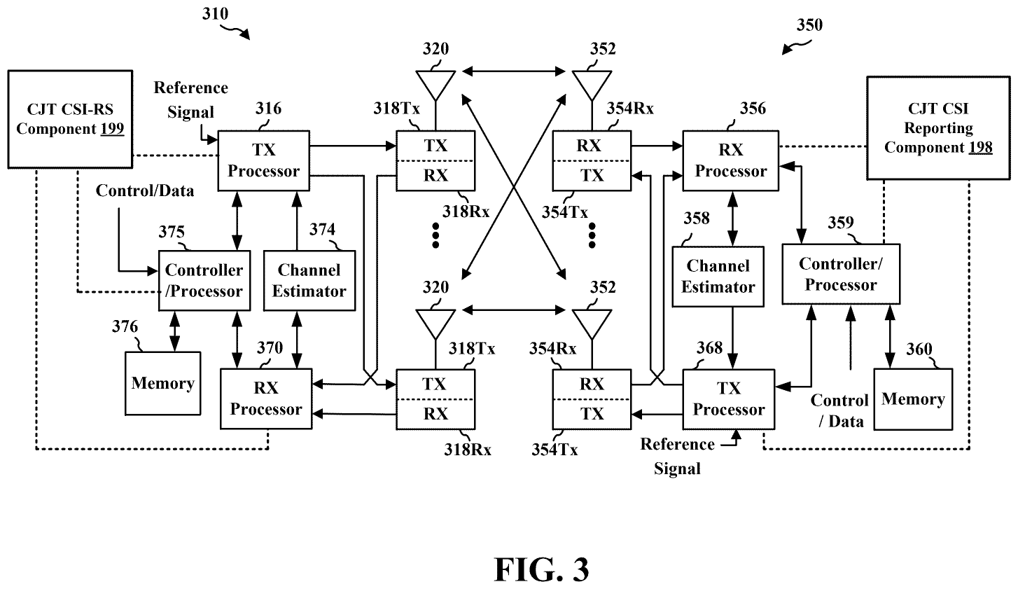

FIG. 3 is a block diagram that illustrates an example of a first wireless device that is configured to exchange wireless communication with a second wireless device. In the illustrated example of FIG. 3, the first wireless device may include a base station 310, the second wireless device may include a UE 350, and the base station 310 may be in communication with the UE 350 in an access network. As shown in FIG. 3, the base station 310 includes a transmit processor (TX processor 316), a transmitter 318Tx, a receiver 318Rx, antennas 320, a receive processor (RX processor 370), a channel estimator 374, a controller/processor 375, and memory 376. The example UE 350 includes antennas 352, a transmitter 354Tx, a receiver 354Rx, an RX processor 356, a channel estimator 358, a controller/processor 359, memory 360, and a TX processor 368. In other examples, the base station 310 and/or the UE 350 may include additional or alternative components.

In the DL, Internet protocol (IP) packets may be provided to the controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 316 and the RX processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna of the antennas 320 via a separate transmitter (e.g., the transmitter 318Tx). Each transmitter 318Tx may modulate a radio frequency (RF) carrier with a respective spatial stream for transmission.

At the UE 350, each receiver 354Rx receives a signal through its respective antenna of the antennas 352. Each receiver 354Rx recovers information modulated onto an RF carrier and provides the information to the RX processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, two or more of the multiple spatial streams may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with the memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization. Channel estimates derived by the channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna of the antennas 352 via separate transmitters (e.g., the transmitter 354Tx). Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna of the antennas 320. Each receiver 318Rx recovers information modulated onto an RF carrier and provides the information to the RX processor 370.

The controller/processor 375 can be associated with the memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the CJT CSI reporting component 198 of FIG. 1.

At least one of the TX processor 316, the RX processor 370, and the controller/processor 375 may be configured to perform aspects in connection with the CJT CSI-RS component 199 of FIG. 1.

In some aspects of wireless communication, joint transmission across multiple TRPs may be enabled. The joint transmission may be a non-coherent JT (NCJT) in which data (layers) may be precoded separately on different TRPs, or may be a CJT in which a same layer may be transmitted via multiple TRPs with phase coherence.

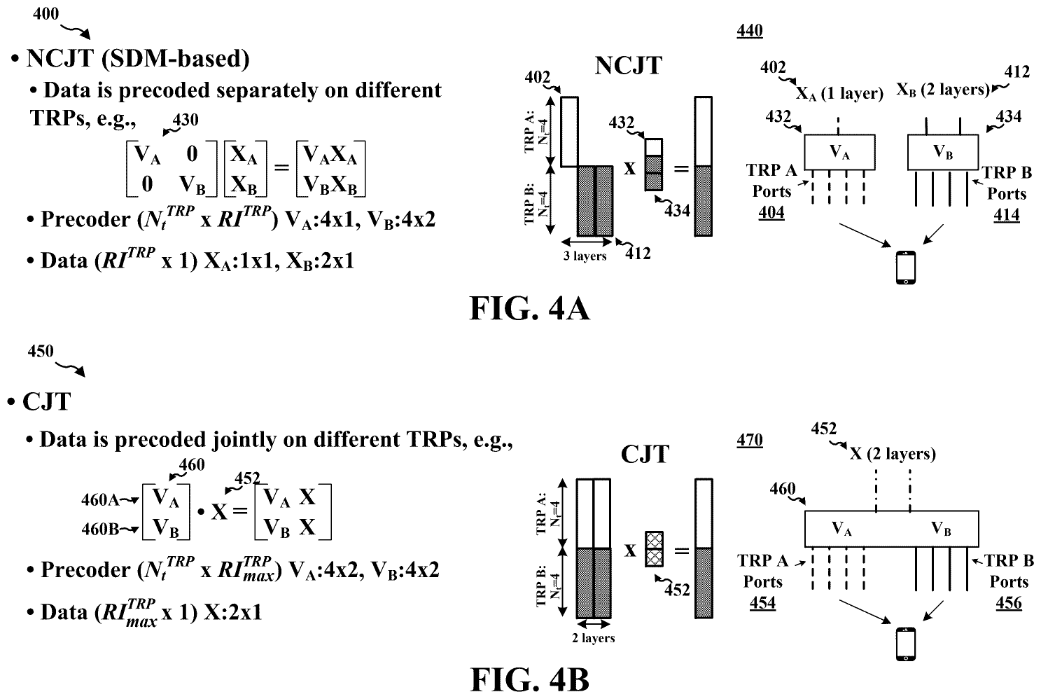

FIG. 4A is a diagram 400 illustrating characteristics of a NCJT, as presented herein. The diagram 400 illustrates that for NCJT, a first set of layers (e.g., a set of one layer) associated with first data 402 (“XA”) may be associated with a first set of TRP ports (e.g., ports of a TRP A 404) while a second set of layers (e.g., a set of two layers) associated with second data 412 (“XB”) may be associated with a second set of TRP ports (e.g., ports of a TRP B 414). For NCJT, the first data 402 and the second data 412 may be precoded with a precoder matrix 430.

The data may be precoded separately on different TRPs. For example, a first column of the precoder matrix 430 indicates that, at a first instance, a first TRP will transmit data and the value “0” indicates that the second TRP will not transmit the data. Then, the second column of the precoder matrix 430 indicates that, at a second instance, the first TRP does not transmit (e.g., based on the value “0”) and that the second TRP will transmit. The data is represented by XA (e.g., the first data 402) and XB (e.g., the second data 412) in which the first data 402 is precoded based on VA 432 and the second data 412 is precoded based on VB 434 for transmission over the TRP A 404 and the TRP B 414, respectively.

In the illustrated example of FIG. 4A, the precoder matrix 430 may have a dimension based on Nₜ^{TRP}×RI^{TRP}, where Nₜ^{TRP} is a value based on a number of transmission antennas of a TRP and RI^{TRP} corresponds to a rank indicator for the TRP, e.g., a number of layers for the TRP. In FIG. 4A, the TRP A 404 includes four antenna ports and 1 layer, e.g., corresponding to V_{A}: 4×1, whereas the TRP B 414 includes four antenna ports and two layers, e.g., corresponding to V_{B}: 4×2. The data may be based on the RI of the corresponding TRP×1, e.g., RI^{TRP}×1, so that the data for the TRP A 404 is X_{A}: 1×1 and the data for the TRP B 414 is X_{B}: 1×1 and 2. In the example of FIG. 4A, the diagram 400 includes a mapping 440 of the data for transmission on the TRPs.

FIG. 4B is a diagram 450 illustrating characteristics of a CJT, as presented herein. The diagram 450 illustrates that, as opposed to NCJT, for CJT a first set of layers (e.g., a set of 2 layers) associated with joint data 452 (“X”) may be jointly precoded to be transmitted from both a TRP A and TRP B in a coherent manner via TRP A ports 454 and TRP B ports 456. For example, the joint data 452 may be precoded based on a precoder matrix 460 including a first precoder component 460A (“V_{A}”) and a second precoder component 460B (“V_{B}”).

FIG. 4B illustrates that the precoder matrix 460 may have a dimension based on Nₜ^{TRP}×RIₘₐₓ^{TRP}, where Nₜ^{TRP} is a value based on a number of transmission antennas of a TRP and RIₘₐₓ^{TRP} corresponds to a maximum rank indicator for the TRPs, e.g., a maximum number of layers for the TRPs. In the example of FIG. 4B, each of the TRP A and the TRP B have four antenna ports and a maximum of 2 layers, so that V_{A}: 4×2 and V_{B}: 4×2. The data may be based on the RIₘₐₓ^{TRP}×1, e.g., RIₘₐₓ^{TRP}×1, so that the data is X: 2×1. In the example of FIG. 4B, the diagram 450 includes a joint mapping 470 of the data for transmission on the TRPs.

In some aspects, the coherence of CJT refers to a phase coherence between TRPs that may be transmitting a same layer as opposed to NCJT in which each layer is transmitted via a single TRP and phase coherence between the TRPs may not provide additional benefits. In some aspects of wireless communication, CJT may be extended to up to 4 TRPs, for example, in a low frequency band such as FR1, based on a type-II codebook. In some aspects, providing additional TRPs for CJT may effectively increase an antenna size for transmitting the low frequency transmission.

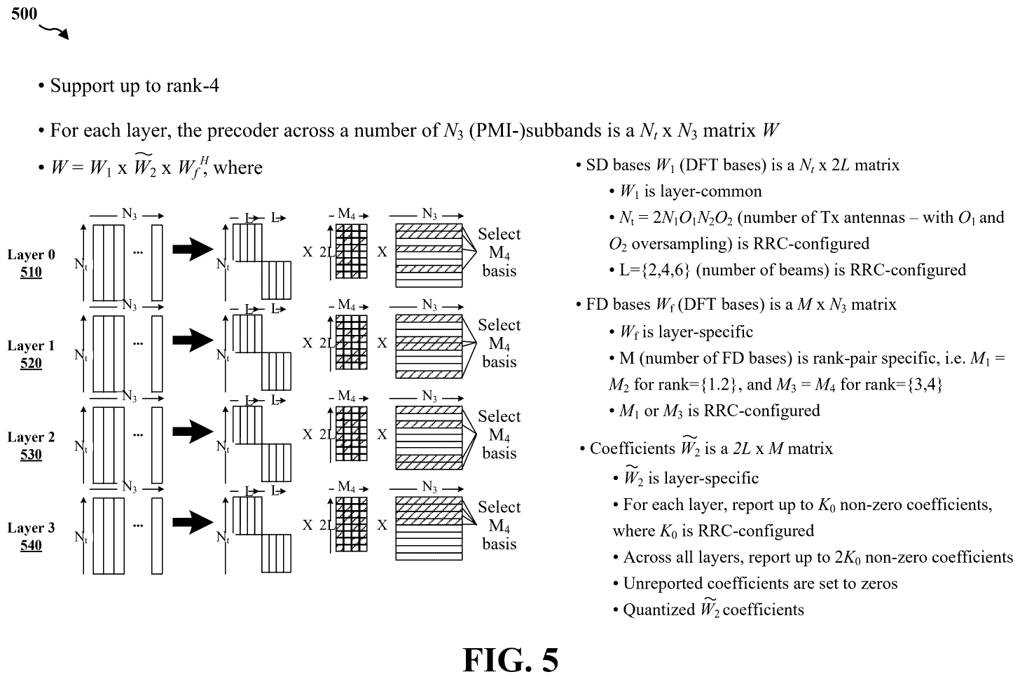

FIG. 5 is a diagram 500 illustrating components of a precoder in some aspects of wireless communication. In the example of FIG. 5, the diagram 500 illustrates that, for each layer, e.g., a first layer 510 (“Layer 0”), a second layer 520 (“Layer 1”), a third layer 530 (“Layer 2”), and a fourth layer 540 (“Layer 3”), a precoder W may be generated based on a first matrix W₁, a second matrix W_{f} or W_{f}^{H}, and a third matrix \tilde{W}₂. The first matrix W₁ may be associated with a spatial domain (SD), the second matrix W_{f} or W_{f}^{H} may be associated with a frequency domain (FD), and the third matrix \tilde{W}₂ may be associated with a set of non-zero coefficients (NZCs).

In some aspects, the first matrix W₁ may be a Nₜ×2L matrix, where Nₜ is a value based on a number of transmission antennas and an oversampling and L is a number of beams used for the joint transmission. In some examples, both Nₜ and L may be RRC-configured. In some aspects, the first matrix W₁, may be selected from a set of SD basis matrixes (e.g., DFT bases) for the spatial domain. The first matrix may be common to layers to be transmitted via a joint transmission, e.g., a NCJT or a CJT. As used herein, the term “SD basis” may also be referred to as a “beam.”

The second matrix W_{f} or W_{f}^{H}, in some aspects, may be an M×N₃ matrix, where M may be an RRC-configured number of FD bases (e.g., FD DFT bases), and N₃ is a number of spatial domain bases. In some examples, M may be rank-pair specific. For example, M₁=M₂ for rank={1, 2} and M₃=M₄ for rank={3, 4}. In some aspects, the second matrix W_{f} or W_{f}^{H} may be layer-specific such that a second matrix W_{f} or W_{f}^{H} may include a first set of selected FD bases associated with a first layer, where the first set of selected FD bases may or may not overlap, completely or partially, with a set of selected FD bases for a second matrix W_{f} or W_{f}^{H} associated with a second layer.

The third matrix \tilde{W}₂, in some aspects, may be a 2L×M matrix including a set of NZCs. In some aspects, the third matrix \tilde{W}₂ is layer-specific and the CSI may report up to K₀ NZCs for each layer and up to 2K₀ NZCs across all the layers, where unreported coefficients are assumed to be, or are, set to zero. The coefficients may be quantized based on a preconfigured and/or may be RRC-configured quantized values.

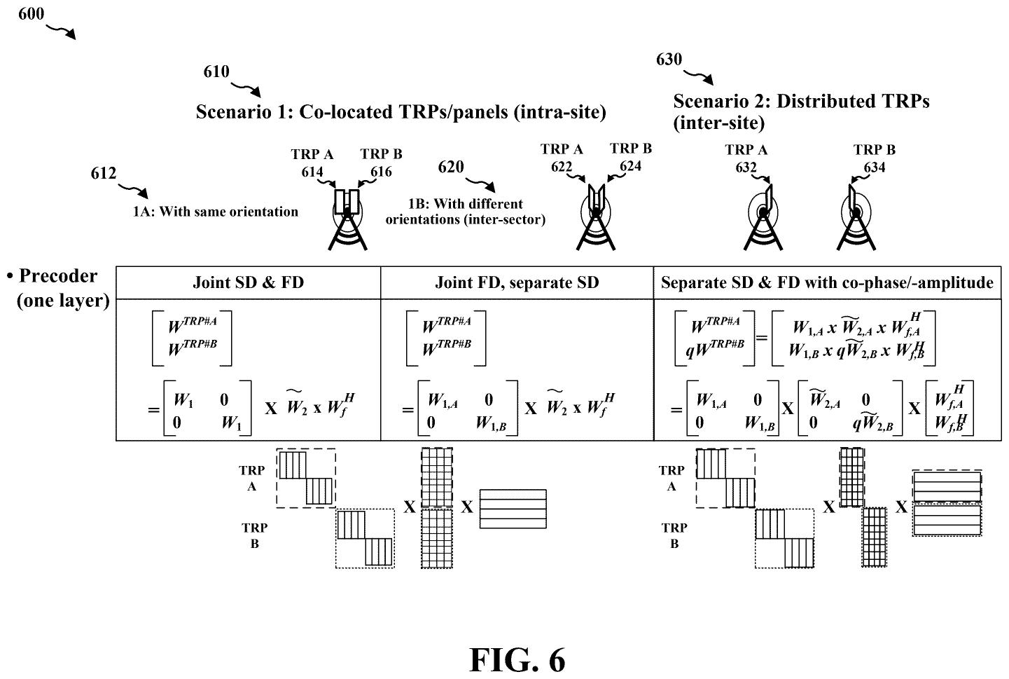

FIG. 6 is a diagram 600 illustrating a set of pre-coder components (e.g., SD component W₁, FD component W_{f} or W_{f}^{H}, and component \tilde{W}₂) used in some aspects of CJT, as presented herein. In a first scenario 610, TRPs may be co-located TRPs/panels and may be referred to as “intra-site” TRPs. In a second scenario 630, TRPs may be distributed TRPs and may be referred to as “inter-site” TRPs.

In examples in which the TRPs are intra-site TRPs (e.g., the first scenario 610), the TRPs may have a same spatial orientation (e.g., a first intra-site scenario 612) or have a different spatial orientation (e.g., a second intra-site scenario 620). For example, in the first intra-site scenario 612 (e.g., scenario 1A) associated with a CJT from multiple co-located TRPs (e.g., antennas at a same site) with a same spatial orientation, a same spatial domain matrix W₁ may be associated with (or used for) each TRP (e.g., for a TRP A 614 and for a TRP B 616). In the second intra-site scenario 620 (e.g., scenario 1B) associated with a CJT for co-located TRPs (e.g., antennas at a same site) with a different spatial orientation, different spatial domain matrices W_{1,A} and W_{1,B} may be associated with (or used for) the different TRPs (e.g., spatial domain matrix W_{1,A} for a TRP A 622 and spatial domain matrix W_{1,B} for a TRP B 624).

In examples in which the TRPs are inter-site TRPs (e.g., the second scenario 630), each component (e.g., the SD component W₁, the FD component W_{f} or W_{f}^{H}, and the component \tilde{W}₂) may be selected independently. For example, different spatial domain matrices W_{1,A} and W_{1,B} may be associated with (or used for) the different TRPs at different sites (e.g., spatial domain matrix W_{1,A} for a TRP A 632 and spatial domain matrix W_{1,B} for a TRP B 634). Additionally, different frequency domain matrices W_{f,A}^{H} or W_{f,B}^{H} may be associated with (or used for) the different TRPs at different sites (e.g., spatial domain matrix W_{f,A}^{H} for the TRP A 632 and spatial domain matrix W_{f,B}^{H} for the TRP B 634). Finally, each of the TRP A 632 and the TRP B 634 may further be associated with different third components \tilde{W}_{2,A} and \tilde{W}_{2,B} respectively. In some aspects, one TRP may further be associated with an additional co-phase/-amplitude coefficient q.

In some aspects of wireless communication, a CSI report may be divided into two parts (e.g., a CSI part 1 and a CSI part 2). For example, having multiple CSI parts may allow for larger CSI payload sizes. In some aspects, the CSI part 1 may have a fixed payload size and may have a smaller payload size than the CSI part 2. In some aspects, the CSI part 1 may include relatively more significant (important) information than the CSI part 2 and may, therefore, be transmitted in a manner to achieve a higher reliability for reception of the CSI part 1. As an example, the CSI part 1 may include rank indicator (RI) information and channel quality indicator (CQI) information. The CSI part 2 may have a variable payload size and the CSI part 1 may also include information used to determine a payload size of the CSI part 2. In some aspects, the CSI part 1 may include non-zero coefficients (NZC) that help to enable a receiver of the CSI report to determine the payload size of the CSI part 2.

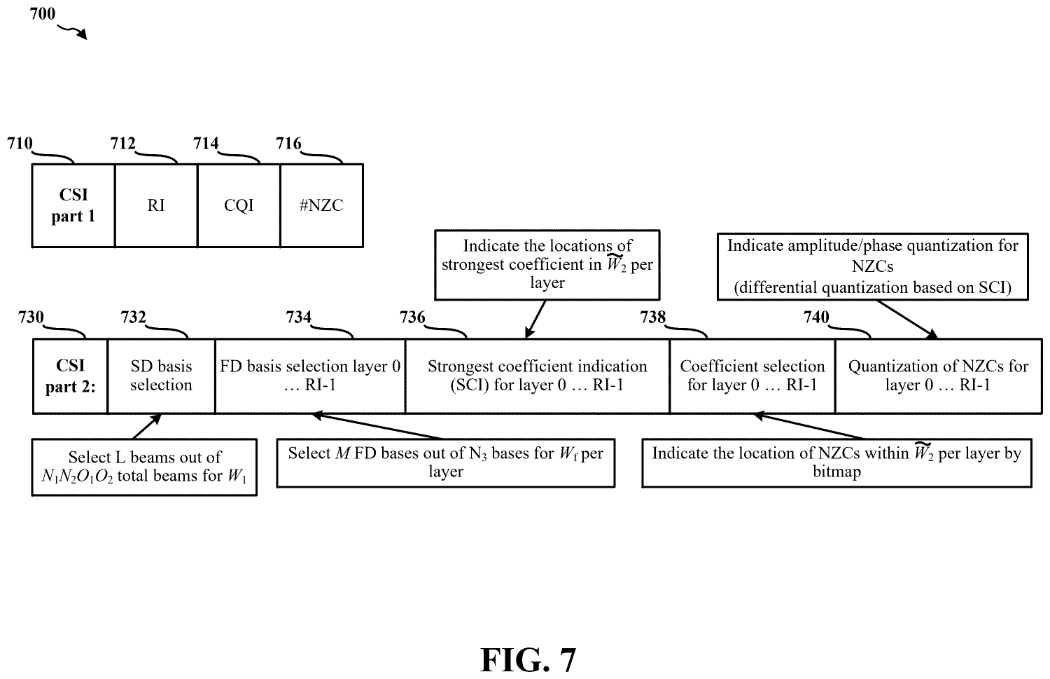

FIG. 7 is a diagram 700 illustrating an example of a two part CSI, as presented herein. In the illustrated example of FIG. 7, the diagram 700 illustrates a first CSI part 710 (e.g., a CSI part 1) and a second CSI part 730 (e.g., a CSI part 2). In the example of FIG. 7, the first CSI part 710 includes an RI field 712, a CQI field 714, and a number of NZC field 716. The RI field 712 may indicate a number of layers associated with the corresponding transmission. The CQI field 714 may indicate CQI information associated with the corresponding transmission. The number of NZC field 716 may indicate NZC information associated with the corresponding transmission. In some examples, both the RI field 712 and the number of NZC field 716 may be used to determine a payload size of the second CSI part 730.

In the example of FIG. 7, the second CSI part 730 includes an SD basis selection field 732 and an FD basis selection field 734. The SD basis selection field 732 may indicate a selection of L beams out of N₁N₂O₁O₂ total beams for the SD component W₁ of the precoder W. The FD basis selection field 734 may indicate a selection of M FD bases out of N₃ bases for the FD component W_{f} or W_{f}^{H} of the precoder W. The selection of the M FD bases may be for each layer. For example, the RI field 712 of the first CSI part 710 may indicate that there are RI layers and, thus, the FD basis selection field 734 may indicate M FD bases for layer 0 to layer RI−1.

In some examples, the second CSI part 730 may include indications of parameters associated with the NZCs indicated in the number of NZC field 716 of the first CSI part 710. For example, the second CSI part 730 may include a strongest coefficient indication field 736 for each of the layers 0 to RI−1, a coefficient selection indication field 738 for each of the layers 0 to RI−1, and a quantization of NZCs indication field 740 for each of the layers 0 to RI−1. The strongest coefficient indication field 736 may indicate the location(s) of the strongest coefficients in the third matrix \tilde{W}₂ of the precoder W. The coefficient selection indication field 738 may indicate the location of the NZCs within the third matrix \tilde{W}₂ for each of the layers 0 to RI−1 (e.g., using a bitmap per layer). The quantization of NZCs indication field 740 may indicate an amplitude and/or phase quantization for NZCs in each layer (e.g., based on the strongest coefficient indication indicated by the strongest coefficient indication field 736 for the corresponding layer).

It may be appreciated that the order of the fields of the first CSI part 710 and/or the second CSI part 730 may be different in other examples. Additionally, or alternatively, the first CSI part 710 and/or the second CSI part 730 may include additional or alternate fields in other examples.

In some aspects of the disclosure, additional information for a CJT is provided in one or more of CSI part 1 or CSI part 2.

In some aspects of wireless communication, a CSI indicating TRP selection for CJT may be associated with an enhanced Type II (eType-II) codebook. While a fixed payload size may be associated with a first part of the CSI, a payload size of the second part of the CSI may be variable and may depend (or be based on) a number of selected TRPs. The variable payload size for the second part of the CSI may be based on one or more of (1) different sizes of the first matrix W₁ for SD basis selection indication (e.g., via the SD basis selection field 732), (2) different sizes of the second matrix W_{f} for FD basis selection indication (e.g., via the indication of the FD basis selection field 734), and/or (3) different sizes for the strongest coefficient indication field 736, the coefficient selection indication field 738, and/or the quantization of NZCs indication field 740 associated with the third matrix \tilde{W}₂.

In examples in which a UE and a network entity are communicating via CJT with multiple TRPs (“mTRP”), the CSI report may indicate TRP selection (and the associated precoder, for example, using the eType-II codebook) of N TRPs, where N is the number of cooperating TRPs assumed in PMI reporting.

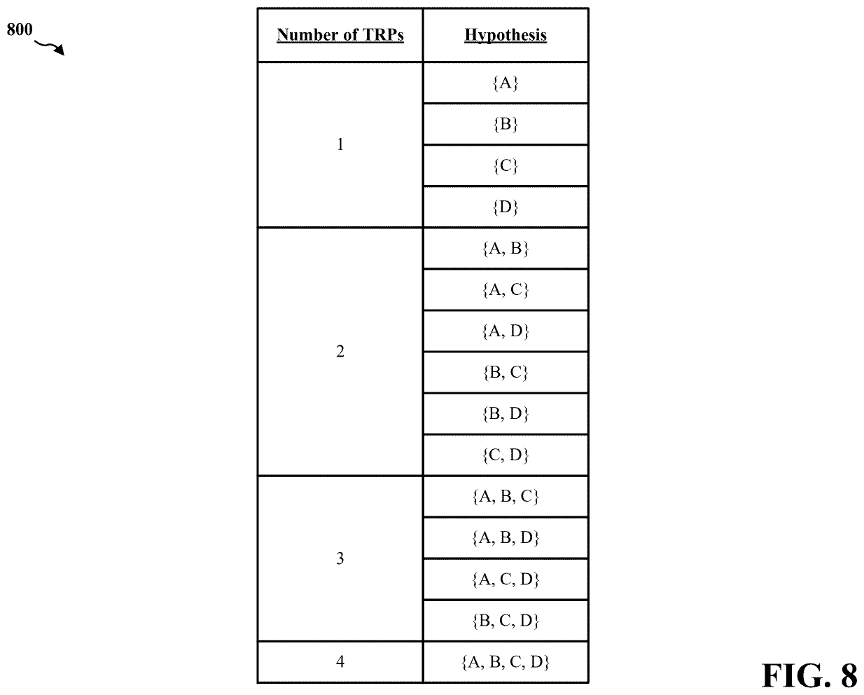

FIG. 8 illustrates an example table 800 including different transmission hypotheses associated with a corresponding number of TRPs, as presented herein. In the example of FIG. 8, CJT communication may be based on up to four TRPs (e.g., a TRP A, a TRP B, a TRP C, and a TRP D). As shown in the table 800, different combinations of TRPs may be used for CJT based on the number of TRPs selected. The table 800 in FIG. 8 illustrates an example in which there may be fifteen transmission hypotheses based on up to four TRPs. For example, the table 800 indicates that when one TRP is selected (e.g., the number of TRPs is 1), there are four transmission hypotheses. For example, the CJT may use the TRP A, the TRP B, the TRP C, or the TRP D. In examples in which two TRPs are selected (e.g., the number of TRPs is 2), there are six possible TRP combinations. For example, a first TRP combination includes the TRP A and the TRP B, a second TRP combination includes the TRP A and the TRP C, a third TRP combination includes the TRP A and the TRP D, a fourth TRP combination includes the TRP B and the TRP C, a fifth TRP combination includes the TRP B and the TRP D, and a sixth TRP combination includes the TRP C and the TRP D. Each of the TRP combinations correspond to a transmission hypothesis, as indicated by the six different transmission hypotheses included in the table 800 and corresponding to two selected TRPs. In a similar manner, when three of the four TRPs are selected (e.g., the number of TRPs is 3), there are four TRP combinations corresponding to the four example transmission hypotheses of the table 800, and when all of the four TRPs are selected (e.g., the number of TRPs is 4), there is one TRP combination corresponding to the one example transmission hypothesis of the table 800. Thus, in the example of FIG. 8, when up to four TRPs may be selected, there are a total of fifteen transmission hypotheses.

In some examples, the N TRPs may be configured by the network (e.g., a network entity, such as a base station or a component of a base station). For example, the N selected TRPs may be configured by the network via higher-layer signaling, such as RRC signaling. In some such examples, the UE may report one transmission hypothesis in the CSI report as the TRP selection is known to the network.

In some examples, the N TRPs are selected by the UE and reported as part of the CSI report. In some such examples, the N TRPs reported by the UE are between 1 and N_{TRP}, where N refers to the number of selected TRPs, and N_{TRP} is the maximum number of cooperating TRPs. In some examples, the value of N_{TRP} may be configured by the network. In examples in which the UE selects the N TRPs, the UE may also report which of the TRPs are selected.

In some examples, the UE may report CSI corresponding to K transmission hypotheses. In some such examples, the K transmission hypotheses may be based on N TRPs, and the N TRPs may be configured by the network (e.g., via higher-layer signaling, such as RRC signaling). For example, in the example of FIG. 8, although the table 800 indicates that there are six transmission hypotheses when two TRPs are selected, the network may configure a subset of the six transmission hypotheses for when two TRPs are selected.

In some examples, in addition to TRP selection, the UE may also select one or more SD bases (e.g., one or more beams) to include in the CSI report. For example, for a TRP that has N₁ by N₂ antenna elements, there may be a total of N₁N₂O₁O₂ total beams, where O₁ is the oversampling in the N₁ direction, and O₂ is the oversampling in the N₂ direction. The UE may select L beams out of the N₁N₂O₁O₂ total beams. The UE may also report the L beams using two fields of the CSI report (e.g., a first sub-field and a second sub-field of the SD basis selection field 732 of FIG. 7). The first sub-field may indicate an oversampling beam group and the second sub-field may indicate the selected L beams (SD bases) within the beam group. In some examples, the first sub-field may be associated with a bit width (or size) of log₂ O₁O₂ bits. The second sub-field may be associated with a bit width of

$$⌈ {log}_{2} ( \begin{matrix}{N}_{1} {N}_{2} \\ L\end{matrix} ) ⌉ bits ,$$

where

$$( \begin{matrix}{N}_{1} {N}_{2} \\ L\end{matrix} )$$

represents the total combinations, and a ceiling function is applied so that a smallest number of bits may be used to indicate the L beams.

In some examples in which multiple TRPs are supported, the indication of the TRP selection and the indication of the SD basis selection may be coupled. For example, a beam may be indicated based on an antenna port of a TRP. Thus, by indicating a particular beam, the corresponding TRP may also be indicated as the TRP may be an intermediate dimension or level of indicating the particular beam.

Aspects disclosed herein provide techniques for utilizing the relationship between TRP selection and SD basis selection to improve communication performance, for example, by reducing overhead associated with indicating the TRP selection and the SD basis selection. In some examples, the number of selected SD bases (e.g., L beams) may be configured to the UE and may represent the total number of selected SD bases across all TRPs. The number of selected SD basis may also be independent of the N TRPs indicated in the CSI report. For example, for the selected N TRPs, the total number of L beams may be defined by Equation 1 (below).

$${\sum }_{n = 1}^{N} {L}_{n} = L \qquad Equation 1$$

In Equation 1, the term n refers to a particular TRP, the term Lₙ refers to the number of beams selected for the n-th TRP, and, thus, the term L refers to the total number of beams selected across the N TRPs.

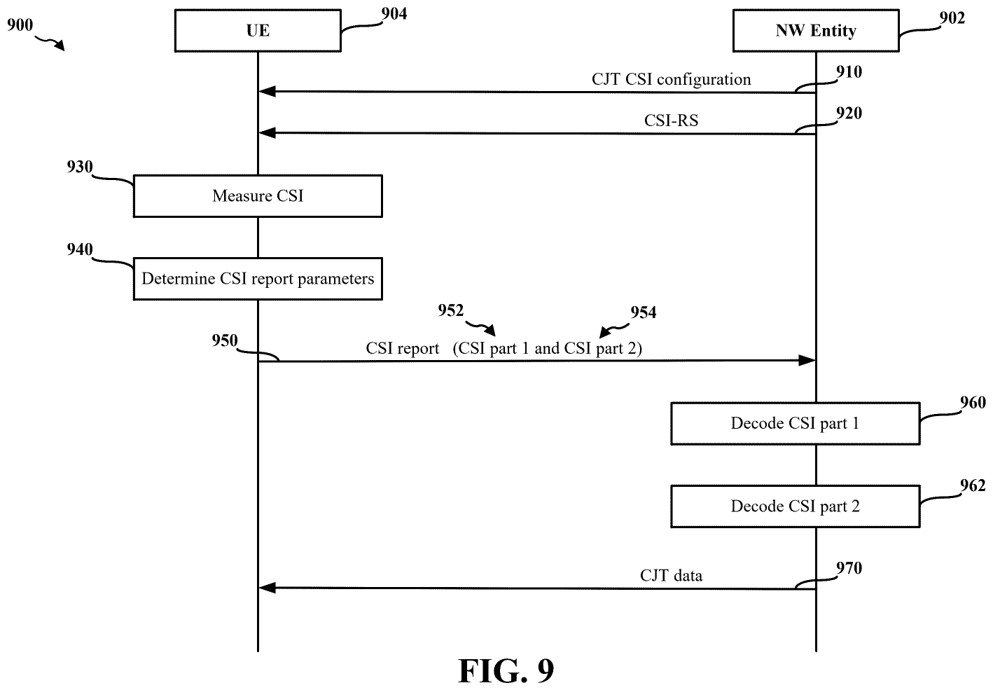

FIG. 9 illustrates an example communication flow 900 between a network entity 902 and a UE 904, as presented herein. One or more aspects described for the network entity 902 may be performed by a component of a base station or a component of a base station, such as a CU, a DU, and/or an RU. Aspects of the network entity 902 may be implemented by the base station 102 of FIG. 1 and/or the base station 310 of FIG. 3. Aspects of the UE 904 may be implemented by the UE 104 of FIG. 1 and/or the UE 350 of FIG. 3. Although not shown in the illustrated example of FIG. 9, in additional or alternative examples, the network entity 902 may be in communication with one or more other base stations or UEs, and/or the UE 904 may be in communication with one or more other base stations or UEs.

In the example of FIG. 9, the network entity 902 and the UE 904 may each include, or be associated with, multiple TRPs and have the capability of CJT. In the illustrated example, the communication flow 900 facilitates the UE 904 exploiting indication redundancy between TRP selection and SD basis selection in two part CSI.

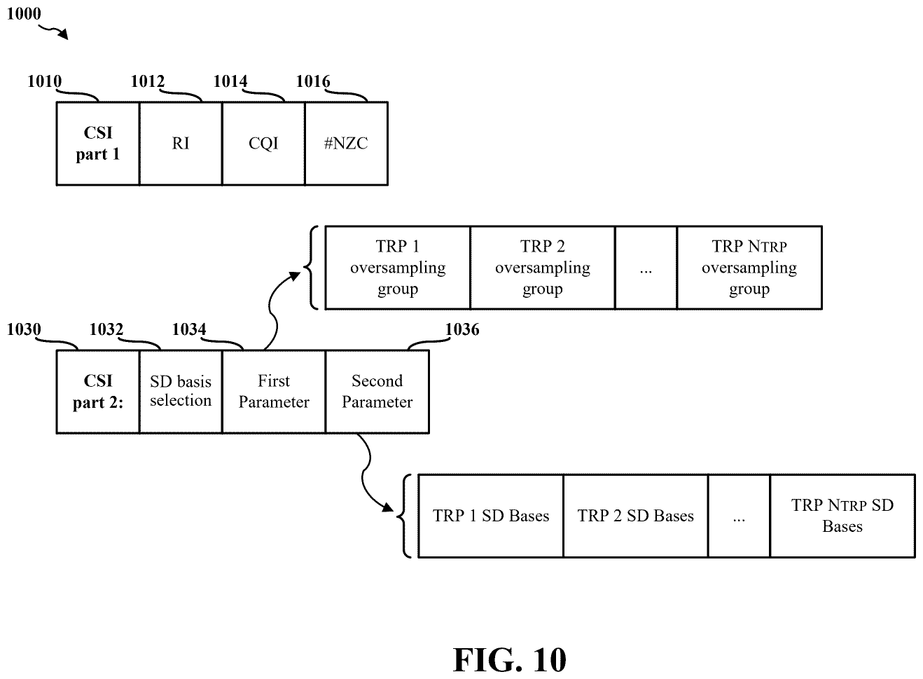

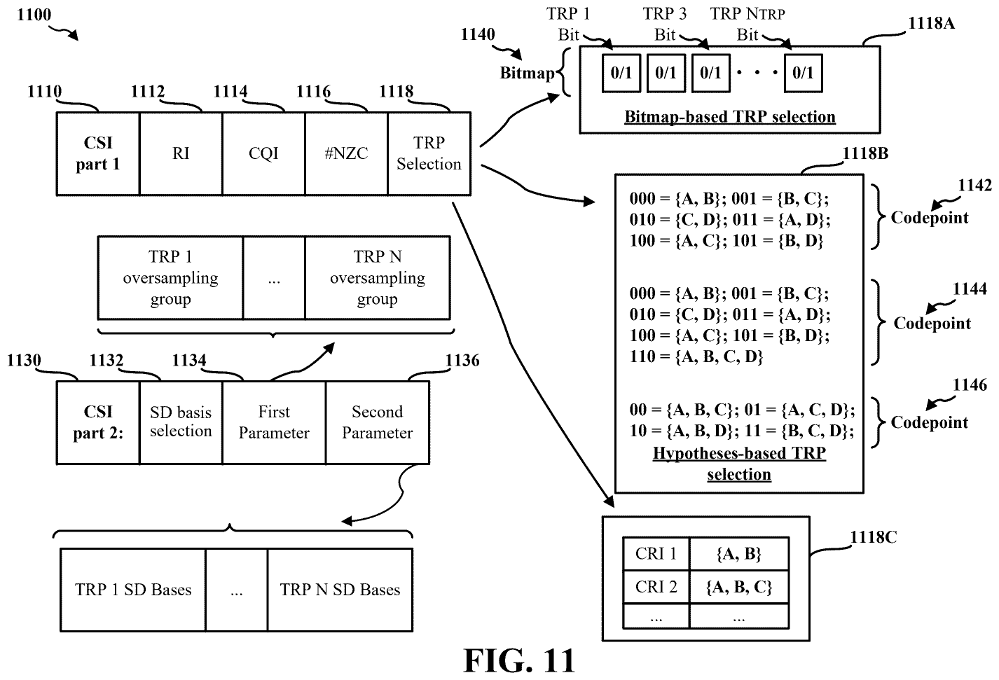

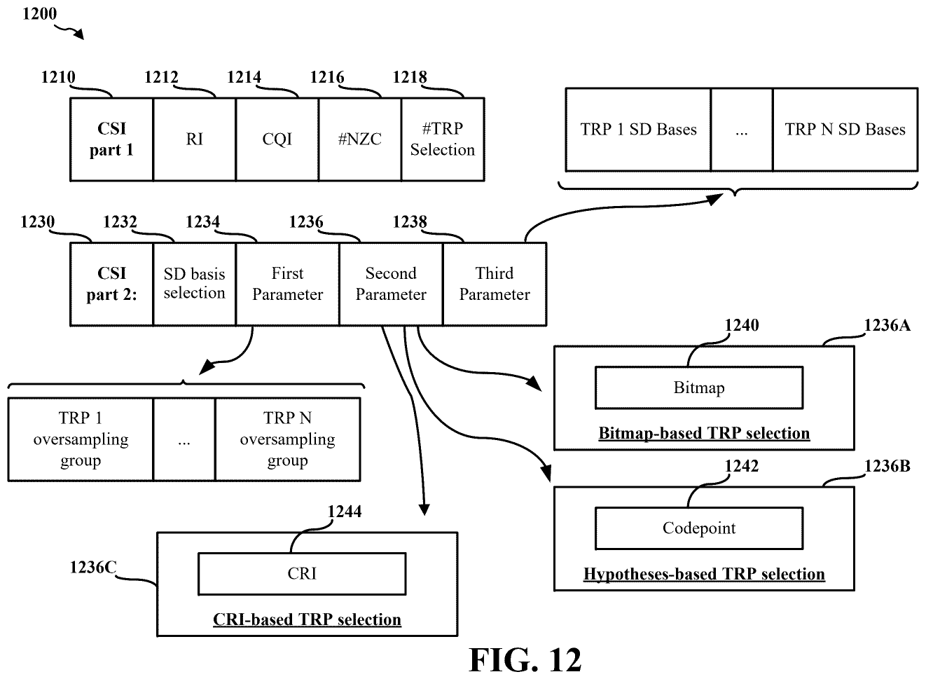

As shown in FIG. 9, the network entity 902 may transmit a CJT CSI configuration 910 that is received by the UE 904. The CJT CSI configuration 910 may configure the UE 904 to use one or more parameters when transmitting a CSI report. Aspects of the one or more parameters associated with a CSI report are described in connection with FIG. 10, FIG. 11, and FIG. 12.

The network entity 902 may transmit a CSI-RS 920 that is received by the UE 904. At 930, the UE 904 may perform measurements on the CSI-RS 920. At 940, the UE 904 may determine a set of parameters for a CSI report 950. The set of parameters for the CSI report 950 may be based on the CJT CSI configuration 910 and the values of the set of parameters may be based on the measurements on the CSI-RS 920.

As shown in FIG. 9, the UE 904 may transmit the CSI report 950 that is received by the network entity 902. The CSI report 950 may be populated with values determined by the UE 904 (e.g., at 940). In the example of FIG. 9, the CSI report 950 includes a first CSI part 952 and a second CSI part 954. The first CSI part 952 may have a fixed payload size and the second CSI part 954 may have a variable payload size indicated by the first CSI part 952. As described in connection with FIG. 10, FIG. 11, and/or FIG. 12, at least one of the first CSI part 952 or the second CSI part 954 may indicate one or more TRPs and SD basis for the CJT of data (e.g., CJT data 970).

At 960, the network entity 902 may decode the first CSI part 952 of the CSI report 950. At 962, the network entity 902 may decode the second CSI part 954 of the CSI report 950. The network entity 902 may use aspects of the first CSI part 952 to determine the payload size of the second CSI part 954. Based on the first CSI part 952 and/or the second CSI part 954, the network entity 902 may transmit CJT data 970 that is received by the UE 904.

FIG. 10 is a diagram illustrating an example CSI report 1000 including a first CSI part 1010 and a second CSI part 1030, as presented herein. Although not shown in the example of FIG. 10, the second CSI part 1030 may include one or more additional or alternate fields, such as the example fields of the second CSI part 730 of FIG. 7. The configuration of the CSI report 1000 may be configured via a CJT CSI configuration, such as the CJT CSI configuration 910 of FIG. 9. In the example of FIG. 10, the CSI report 1000 includes one or more parameters (or fields) that facilitate indicating a TRP selection and an SD basis selection.

In the illustrated example of FIG. 10, the first CSI part 1010 may be similar to the first CSI part 710 of FIG. 7. For example, the first CSI part 1010 of FIG. 10 includes an RI field 1012, a CQI field 1014, and a number of NZC field 1016.

As shown in FIG. 10, the second CSI part 1030 may include an SD basis selection field 1032. For a maximum number of TRPs configured for CSI measurement (N_{TRP}), each of which is configured with N₁N₂O₁O₂ total beams, the SD basis selection field 1032 may include a first parameter 1034 and a second parameter 1036. The first parameter 1034 may indicate an oversampling beam group for each TRP, respectively. The size (e.g., bit width) of the first parameter 1034 may be based on the maximum number of TRPs available for CJT (N_{TRP}) and a quantity of oversampling beam groups (O₁O₂). For example, the size of the first parameter 1034 may be N_{TRP} log₂ O₁O₂ bits.

The second parameter 1036 may indicate the selected L beams out of N_{TRP}N₁N₂ beams. The size (e.g., bit width) of the second parameter 1036 may be based on the maximum number of TRPs available for CJT (N_{TRP}), a number of beams for each TRP (N₁N₂), and the total number of selected beams (L). For example, the size of the second parameter 1036 may be

$$⌈ {log}_{2} ( \begin{matrix}{N}_{T R P} {N}_{1} {N}_{2} \\ L\end{matrix} ) ⌉ bits .$$

It may be appreciated that the second parameter 1036 may implicitly indicate which N TRPs out of all of the TRPs (N_{TRP}) are selected, as well as the selected number of SD bases (Lₙ) for each TRP n=1, . . . N.

As shown in the example of FIG. 10, the first parameter 1034 and the second parameter 1036 are included in the second CSI part 1030 of the CSI report 1000.

In the example of FIG. 10, it may be noted that when the number of selected TRPs is less than the maximum number of TRPs (e.g., N<N_{TRP}), to ensure a pre-fixed uplink control information (UCI) payload size, the first parameter 1034 and the second parameter 1036 are configured using a total number of bits corresponding to the maximum possible number of TRPs (e.g., N_{TRP}). That is, since the fields of the first CSI part 1010 of FIG. 10 are the same as the fields of the first CSI part 710 of FIG. 7, and to enable the first CSI part 1010 to indicate the payload size of the second CSI part 1030, the sizes of the first parameter 1034 and the second parameter 1036 are fixed based on the maximum number of possible TRPs (N_{TRP}).

FIG. 11 is a diagram illustrating another example CSI report 1100 including a first CSI part 1110 and a second CSI part 1030, as presented herein. Although not shown in the example of FIG. 11, the second CSI part 1130 may include one or more additional or alternate fields, such as the example fields of the second CSI part 730 of FIG. 7. The configuration of the CSI report 1100 may be configured via a CJT CSI configuration, such as the CJT CSI configuration 910 of FIG. 9. Similar to the example CSI report 1000 of FIG. 10, the CSI report 1100 includes one or more parameters (or fields) that facilitate indicating a TRP selection and an SD basis selection.

In the illustrated example of FIG. 11, the first CSI part 1110 includes an RI field 1112, a CQI field 1114, a number of NZC field 1116, and a TRP selection field 1118. The TRP selection field 1118 may be a layer-common TRP selection. The TRP selection field 1118 may indicate a set of TRPs associated with different layers being transmitted via the CJT. The first CSI part 1110 may have a payload size that is fixed and, thus, is the same size regardless of the number of TRP indicated.

In some examples, the TRP selection field 1118 may be implemented as a bitmap-based TRP selection field 1118A. The bitmap-based TRP selection field 1118A may include a bitmap 1140 that includes a number of bits equal to a number (N_{TRP}) of possible TRPs available for the CJT. For example, for N_{TRP}=4, the bitmap 1140 may include a set of 4 bits with each bit corresponding to a particular TRP in the set of four possible TRPs. As an example, a value of “0” may indicate that the corresponding TRP is not selected, and a value of “1” may indicate that the corresponding TRP is selected. As an example, a first bit of the bitmap may correspond to TRP A, a second bit of the bitmap may correspond to TRP B, a third bit of the bitmap may correspond to TRP C, and a fourth bit of the bitmap may correspond to TRP D. In such an example, a bitmap value of {0101} may indicate that TRP B and TRP D are selected for the CJT data transmission. Alternatively, a value of “0” may indicate that the corresponding TRP is selected, and a value of “1” may indicate that the corresponding TRP is not selected. In such an example, the bitmap value of {0101} would indicate that TRP A and TRP C are selected.

In some examples, the TRP selection field 1118 may be implemented via a hypotheses-based TRP selection field 1118B. For example, for a configured number of TRPs, a limited number of combinations of TRPs may be possible. In some such examples, a codepoint may be used to identify a selected set of TRPs. For example, the set of possible TRPs may include sets of two TRPs, as shown in a first codepoint 1142. In the example of the first codepoint 1142, the codepoint has three bits, with a value of “000” indicating that the TRP A and the TRP B are selected for the CJT of data, a value of “010” indicating that the TRP C and the TRP D are selected for the CJT data, and so forth. Each of the different values of the first codepoint 1142 may correspond to a different combination of TRPs.

In other examples, the set of possible TRPs may include different combinations of one TRP, two TRPs, three TRPs, and/or four TRPs, as shown in the example table 800 of FIG. 8. For example, a second codepoint 1144 includes possible sets of two TRPs and a set of four TRPs. A third codepoint 1146 includes sets of three TRPs. In the example codepoints of the hypotheses-based TRP selection field 1118B, the number of bits used to identify the selected TRPs depends on the total number of possible sets of TRPs. For example, the first codepoint 1142 illustrates that, for a codepoint corresponding to the possible groups of two TRPs, where the group size may be configured to n_{TRP}, from a set of four TRPs, where the total number of TRPs may be N_{TRP}, three bits are sufficient to identify the possible groups of two TRPs. In general, for a fixed group size and number of TRPs, the number of bits used may be given by

$$⌈ {log}_{2} ( \begin{matrix}{N}_{T R P} \\ {n}_{T R P}\end{matrix} ) ⌉$$

(e.g., the smallest integer larger than or equal to the base 2 logarithm of the number of combination of n_{TRP} elements from a set of N_{TRP} elements).

In some aspects, the selected TRPs may be indicated via a CSI-RS resource indicator (CRI) that indicates the one or more TRPs. For example, a plurality of sets of CSI-RS resources indicated by a CRI may be mapped to a corresponding plurality of sets of selected TRP, such that a CRI may indicate a selected set of TRPs in addition to CSI-RS resources.

In some examples, the TRP selection field 1118 may be implemented via a CRI-based TRP selection field 1118C. For example, different CRI values may map to different selected TRPs. In the example of FIG. 11, a first value of a CRI (e.g., “CRI 1”) maps to a first selected set of TRPs (e.g., TRP A and TRP B). A second value of CRI (e.g., “CRI 2”) maps to a second selected set of TRPs (e.g., TRP A, TRP B, and TRP C), and so forth. Each of the different values of the CRI may correspond to a different combination of TRPs.

Similar to the example second CSI part 1030 of FIG. 10, the second CSI part 1130 of FIG. 11 may include an SD basis selection field 1132 including a first parameter 1134 and a second parameter 1136. The first parameter 1134 may indicate an oversampling beam group for each of the selected TRPs, respectively. Thus, in contrast to the first parameter 1034 of FIG. 10, which is based on the maximum number of TRPs available for CJT (N_{TRP}), the first parameter 1134 of FIG. 11 may have a size based on the number of selected TRPs (N). For example, the size of the first parameter 1134 may be N log₂ O₁O₂ bits.

The second parameter 1136 may indicate the selected L beams out of NN₁N₂ beams in a joint way. The size (e.g., bit width) of the second parameter 1136 may be based on the number of selected TRPs (N), a number of beams for each TRP (N₁N₂), and the total number of selected beams (L). For example, the size of the second parameter 1136 may be

$$⌈ {log}_{2} ( \begin{matrix}N {N}_{1} {N}_{2} \\ L\end{matrix} ) ⌉ bits .$$

It may be appreciated that the second parameter 1136 may implicitly indicate which N TRPs out of all of the TRPs (N_{TRP}) are selected, as well as the selected number of SD bases (Lₙ) for each TRP n=1, . . . . N.

In some examples, another parameter may be configured to report a UE-determined number of SD bases (Lₙ) for each TRP n=1, . . . . N, satisfying Equation 1 (reproduced below).

$${\sum }_{n = 1}^{N} {L}_{n} = L \qquad Equation l$$

In some such examples, the second parameter 1136 may indicate the selected total beams (L) for all of the N TRPs separately, and based on an indication of selecting the number of SD bases (Lₙ) out of a total number of beams for one TRP (N₁N₂). For example, the size of the second parameter 1136 may be determined by Equation 2 (below) or Equation 3 (below).

$${\sum }_{n = 1}^{N} ⌈ {log}_{2} ( \begin{matrix}{N}_{1} {N}_{2} \\ {L}_{n}\end{matrix} ) ⌉ = number of bits \qquad Equation 2$$

$$⌈ {\sum }_{n = 1}^{N} {log}_{2} ( \begin{matrix}{N}_{1} {N}_{2} \\ {L}_{n}\end{matrix} ) ⌉ = number of bits \qquad Equation 3$$

Equation 2 may be used when the second parameter 1136 indicates per-TRP individually encoded SD basis selection. Equation 3 may be used when the second parameter 1136 indicates a jointly encoded SD basis selection for all TRPs (N_{TRP}).

As shown in the example of FIG. 11, the TRP selection field 1118 may be included in the first CSI part 1110, and the first parameter 1134 and the second parameter 1136 may be included in the second CSI part 1130 of the CSI report 1100.

In the example of FIG. 11, it may be noted that the TRP selection field 1118 may indicate the size of the second CSI part 1130. For example, when the TRP selection field 1118 is implemented via the bitmap-based TRP selection field 1118A, the value of the bitmap 1140 may indicate how many TRPs out of the maximum number of TRPs are selected. For example, a bitmap value of {0101} may indicate that TRP B and TRP D are selected for the CJT data transmission, and, thus, that two of the four TRPs are selected. A receiving device (e.g., the network entity 902 of FIG. 9) may then use the number of selected TRPs (e.g., two TRPs) to determine the payload size of the second CSI part 1130 by, for example, determining the size of the first parameter 1134 when two TRPs are selected, and determining the size of the second parameter 1136 when two TRPs are selected.

FIG. 12 is a diagram illustrating another example CSI report 1200 including a first CSI part 1210 and a second CSI part 1230, as presented herein. Although not shown in the example of FIG. 12, the second CSI part 1230 may include one or more additional or alternate fields, such as the example fields of the second CSI part 730 of FIG. 7. The configuration of the CSI report 1200 may be configured via a CJT CSI configuration, such as the CJT CSI configuration 910 of FIG. 9. Similar to the example CSI report 1000 and the example CSI report 1100, the CSI report 1200 includes one or more parameters (or fields) that facilitate indicating a TRP selection and an SD basis selection.

In the illustrated example of FIG. 12, the first CSI part 1210 includes an RI field 1212, a CQI field 1214, a number of NZC field 1216, and a number of TRP selection field 1218. The number of TRP selection field 1218 indicates the number of selected TRPs (N). The size (e.g., bit width) of the number of TRP selection field 1218 may be based on the maximum number of TRPs (N_{TRP}). For example, the size of the number of TRP selection field 1218 may be calculated as ┌log₂ N_{TRP}┐ (e.g., the smallest integer larger than or equal to the base 2 logarithm of the maximum number of TRPs (N_{TRP})). The first CSI part 1210 may have a payload size that is fixed and, thus, is the same size regardless of the number of TRP indicated by the number of TRP selection field 1218.

Similar to the example second CSI part 730 of FIG. 7, the second CSI part 1230 of FIG. 12 may include an SD basis selection field 1232. As shown in FIG. 12, the SD basis selection field 1232 may include a first parameter 1234, a second parameter 1236, and a third parameter 1238. Aspects of the first parameter 1234 may be similar to the first parameter 1134 of FIG. 11. For example, the first parameter 1234 may indicate an oversampling beam group for each of the selected TRPs, respectively. Thus, the first parameter 1234 of FIG. 12 may have a size based on the number of selected TRPs (N), which may be the same as the first parameter 1134 of FIG. 11. For example, the size of the first parameter 1234 may be N log₂ O₁O₂ bits.

The second parameter 1236 may indicate the selected N TRPs. Aspects of the second parameter 1236 may be similar to the TRP selection field 1118 of FIG. 11. For example, the second parameter 1236 may be implemented via a bitmap-based TRP selection 1236A that is similar to the bitmap-based TRP selection field 1118A of FIG. 11. For example, a bitmap 1240 may indicate which of the maximum number of TRPs (N_{TRP}) is selected by the UE in the CSI report 1200. In such examples, the size of the second parameter 1236 may be given by

$$⌈ {log}_{2} ( \begin{matrix}{N}_{TRP} \\ N\end{matrix} ) ⌉$$

(e.g., the smallest integer larger than or equal to the base 2 logarithm of the number of combinations of N elements from a set of N_{TRP} elements).

In another example, the second parameter 1236 may be implemented via a hypotheses-based TRP selection 1236B that is similar to the hypotheses-based TRP selection field 1118B of FIG. 11. For example, for a configured number of TRPs, a limited number of combinations of TRPs may be possible. In some such examples, a codepoint 1242 may be used to identify a selected set of TRPs. In such examples, for a fixed group size and number of TRPs, the number of bits used may be given by

$$⌈ {log}_{2} ( \begin{matrix}{N}_{TRP} \\ {n}_{TRP}\end{matrix} ) ⌉$$

(e.g., the smallest integer larger than or equal to the base 2 logarithm of the number of combination of n_{TRP} elements from a set of N_{TRP} elements).

In another example, the second parameter 1236 may be implemented via a CRI-based selection 1236C that is similar to the CRI-based TRP selection field 1118C of FIG. 11. For example, a plurality of sets of CSI-RS resources indicated by a CRI may be mapped to a corresponding plurality of sets of selected TRP, such that a CRI may indicate a selected set of TRPs in addition to CSI-RS resources. For example, a CRI 1244 may indicate which of the maximum number of TRPs (N_{TRP}) is selected by the UE in the CSI report 1200.

The third parameter 1238 may indicate the selected L beams out of NN₁N₂ beams in a joint way, which may be similar to the second parameter 1136 of FIG. 11. The size (e.g., bit width) of the third parameter 1238 may be based on the number of selected TRPs (N), a number of beams for each TRP (N₁N₂), and the total number of selected beams (L). For example, the size of the third parameter 1238 may be

$$⌈ {log}_{2} ( \begin{matrix}N {N}_{1} {N}_{2} \\ L\end{matrix} ) ⌉$$

bits. It may be appreciated that the third parameter 1238 may implicitly indicate which N TRPs out of all of the TRPs (N_{TRP}) are selected, as well as the selected number of SD bases (Lₙ) for each TRP n=1, . . . N.

As shown in the example of FIG. 12, the number of TRP selection field 1218 may be included in the first CSI part 1210, and the first parameter 1234, the second parameter 1236, and the third parameter 1238 may be included in the second CSI part 1230 of the CSI report 1200.

In the example of FIG. 12, it may be noted that the number of TRP selection field 1218 may indicate the size of the second CSI part 1230. For example, the value of the number of TRP selection field 1218 may indicate how many TRPs out of the maximum number of TRPs (N_{TRP}) are selected. A receiving device (e.g., the network entity 902 of FIG. 9) may then use the number of selected TRPs to determine the payload size of the second CSI part 1230, for example, by determining the size of the first parameter 1234 when N TRPs are selected, by determining the size of the second parameter 1236 when N TRPs are selected, and by determining the size of the third parameter 1238 when N TRPs are selected.

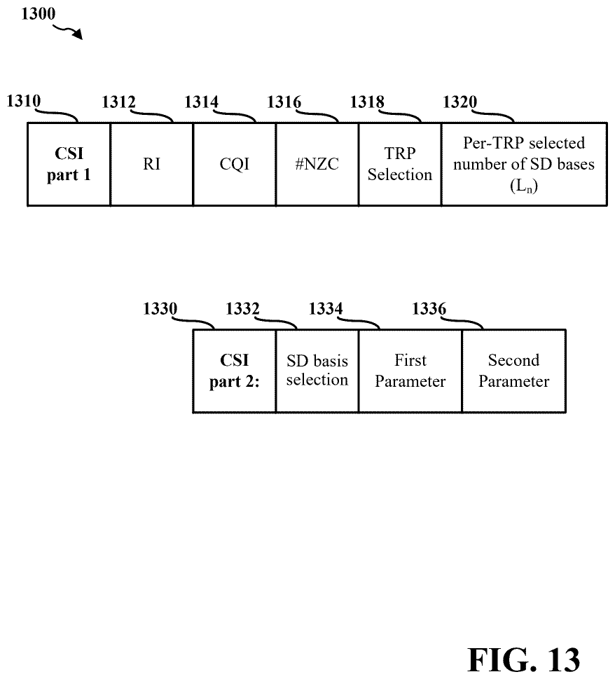

FIG. 13 is a diagram illustrating another example CSI report 1300 including a first CSI part 1310 and a second CSI part 1330, as presented herein. Although not shown in the example of FIG. 13, the second CSI part 1330 may include one or more additional or alternate fields, such as the example fields of the second CSI part 730 of FIG. 7. The configuration of the CSI report 1300 may be configured via a CJT CSI configuration, such as the CJT CSI configuration 910 of FIG. 9. Similar to the example CSI report 1000 of FIG. 10, the CSI report 1100 of FIG. 11, and the CSI report 1200 of FIG. 12, the CSI report 1300 includes one or more parameters (or fields) that facilitate indicating a TRP selection and an SD basis selection.

In the illustrated example of FIG. 13, the first CSI part 1310 includes an RI field 1312, a CQI field 1314, a number of NZC field 1316, a TRP selection field 1318, and a per-TRP selected number of SD bases field 1320. The TRP selection field 1318 may be a layer-common TRP selection. The TRP selection field 1318 may indicate a set of TRPs associated with different layers being transmitted via the CJT. The first CSI part 1110 may have a payload size that is fixed and, thus, is the same size regardless of the number of TRP indicated. Aspects of the TRP selection field 1318 may be implemented by the TRP selection field 1118 of FIG. 11. For example, the TRP selection field 1318 may be implemented as a bitmap-based TRP selection field, a hypotheses-based TRP selection field or a CRI-based TRP selection field.

The per-TRP selected number of SD bases field 1320 may be configured to report a UE-determined number of SD bases (Lₙ) for each TRP n=1, . . . N, satisfying Equation 1 (reproduced below).

$${\sum }_{n = 1}^{N} {L}_{n} = L \qquad Equation l$$

Similar to the example second CSI part 1030 of FIG. 10, the second CSI part 1330 of FIG. 13 may include an SD basis selection field 1332 including a first parameter 1334 and a second parameter 1336. Aspects of the first parameter 1334 and the second parameter 1336 may be similar to the first parameter 1134 and the second parameter 1136, respectively, of FIG. 11.

As shown in the example of FIG. 13, the TRP selection field 1318 and the per-TRP selected number of SD bases field 1320 may be included in the first CSI part 1310, and the first parameter 1334 and the second parameter 1336 may be included in the second CSI part 1330 of the CSI report 1300.

For example, the size of the second parameter 1336 may be determined by Equation 2 (below) or Equation 3 (below).

$${\sum }_{n = 1}^{N} ⌈ {log}_{2} ( \begin{matrix}{N}_{1} {N}_{2} \\ {L}_{n}\end{matrix} ) ⌉ = number of bits \qquad Equation 2$$

$$⌈ {\sum }_{n = 1}^{N} {log}_{2} ( \begin{matrix}{N}_{1} {N}_{2} \\ {L}_{n}\end{matrix} ) ⌉ = number of bits \qquad Equation 3$$

Equation 2 may be used when the second parameter 1336 indicates per-TRP individually encoded SD basis selection. Equation 3 may be used when the second parameter 1336 indicates a jointly encoded SD basis selection for all TRPs (N_{TRP}).

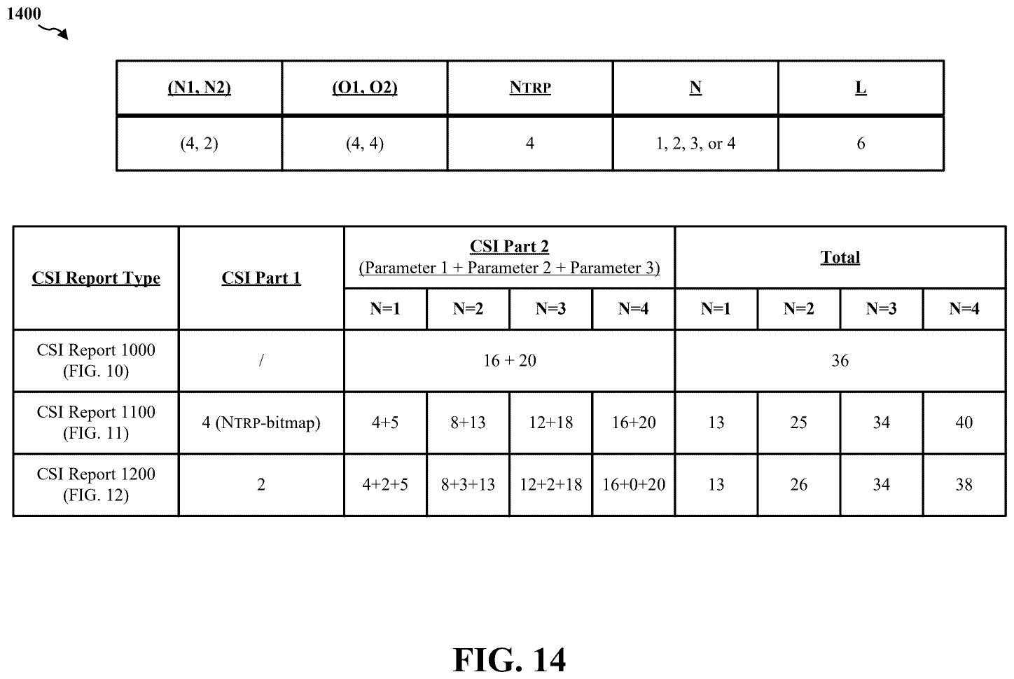

An example of CSI overhead based on the example CSI report 1000 of FIG. 10, the example CSI report 1100 of FIG. 11, and the example CSI report 1200 of FIG. 12 are shown in an example table 1400 of FIG. 14. In the example of FIG. 14, the values of certain parameters are shown. For example, the number of antenna elements in the N1, N2 directions is four and two, respectively, the oversampling in the N1, N2 directions (O₁O₂) is four and four, respectively, a maximum number of TRPs (N_{TRP}) is four, and a number of selected beams (L) is 6. The number of selected TRPs (N) may be 1, 2, 3, or 4.

As shown in FIG. 14, based on the CSI report 1000 of FIG. 10, the size of the first CSI part is unchanged, and the size of the second CSI part is based on the size of the first parameter (16) and the size of the second parameter (20). The size of the first parameter may be calculated based on N_{TRP} log₂ O₁O₂=4 log₂ 4*4=16 bits. The size of the second parameter may be calculated based on

$$⌈ {log}_{2} ( \begin{matrix}{N}_{TRP} {N}_{1} {N}_{2} \\ L\end{matrix} ) ⌉ = ⌈ {log}_{2} ( \begin{matrix}4 * 4 * 2 \\ 6\end{matrix} ) ⌉ = 20 bits .$$

Thus, the overhead added to CSI for indicating the TRP selection and the SD basis selection based on the CSI report 1000 of FIG. 10 is 36 bits, and is the same regardless of the number of selected TRPs.

As shown in FIG. 14, based on the CSI report 1100 of FIG. 11, the size of the first CSI part is 4 bits, for example, based on the bitmap-based TRP selection field 1118A. The size of the second CSI part is based on the size of the first parameter 1134 and the second parameter 1136. As an example, for two selected TRPs (e.g., N=2), the size of the first parameter may be calculated based on N log₂ O₁O₂₌₂ log₂ 4*4=8 bits. The size of the second parameter may be calculated based on

$$⌈ {log}_{2} ( \begin{matrix}N {N}_{1} {N}_{2} \\ L\end{matrix} ) ⌉ = ⌈ {log}_{2} ( \begin{matrix}2 * 4 * 2 \\ 6\end{matrix} ) ⌉ = 13 bits .$$

Thus, the overhead added to CSI for indicating the TRP selection and the SD basis selection based on the CSI report 1100 of FIG. 11 is 25 bits (e.g., 4+8+13=25 bits). As another example, for four selected TRPs (e.g., N=4), the size of the first parameter may be calculated based on N log₂ O₁O₂₌₄ log₂ 4*4=16 bits. The size of the second parameter may be calculated based on

$$⌈ {log}_{2} ( \begin{matrix}N {N}_{1} {N}_{2} \\ L\end{matrix} ) ⌉ = ⌈ {log}_{2} ( \begin{matrix}4 * 4 * 2 \\ 6\end{matrix} ) ⌉ = 20 bits .$$

Thus, the overhead added to CSI for indicating the TRP selection and the SD basis selection based on the CSI report 1100 of FIG. 11 is 40 bits (e.g., 4+16+20=40 bits).

As shown in FIG. 14, based on the CSI report 1200 of FIG. 12, the size of the first CSI part is 2 additional bits, which may be calculated based on ┌log₂ N_{TRP}┐=┌log₂ 4┐=2 bits. The size of the second CSI part is based on the size of the first parameter 1234, the second parameter 1236, and the third parameter 1238. As an example, for two selected TRPs (e.g., N=2), the size of the first parameter may be calculated based on N log₂ O₁O₂₌₂ log₂ 4*4=8 bits. The size of the second parameter may be calculated based on

$$⌈ {log}_{2} ( \begin{matrix}{N}_{TRP} \\ N\end{matrix} ) ⌉ = ⌈ {log}_{2} ( \begin{matrix}4 \\ 2\end{matrix} ) ⌉ = 3 bits .$$

The size of the third parameter may be calculated based on

$$⌈ {log}_{2} ( \begin{matrix}N {N}_{1} {N}_{2} \\ L\end{matrix} ) ⌉ = ⌈ {log}_{2} ( \begin{matrix}2 * 4 * 2 \\ 6\end{matrix} ) ⌉ = 13 bits .$$

Thus, the overhead added to CSI for indicating the TRP selection and the SD basis selection based on the CSI report 1200 of FIG. 12 is 26 bits (e.g., 2+8+3+13=26 bits). As another example, for four selected TRPs (e.g., N=4), the size of the first parameter may be calculated based on N log₂ O₁O₂₌₄ log₂ 4*4=16 bits. The size of the second parameter may be calculated based on

$$⌈ {log}_{2} ( \begin{matrix}{N}_{TRP} \\ N\end{matrix} ) ⌉ = ⌈ {log}_{2} ( \begin{matrix}4 \\ 4\end{matrix} ) ⌉ = 0 bits .$$

The size of the third parameter may be calculated based

$$⌈ {log}_{2} ( \begin{matrix}N {N}_{1} {N}_{2} \\ L\end{matrix} ) ⌉ = ⌈ {log}_{2} ( \begin{matrix}4 * 4 * 2 \\ 6\end{matrix} ) ⌉ = 20 bits .$$

Thus, the overhead added to CSI for indicating the TRP selection and the SD basis selection based on the CSI report 1200 of FIG. 12 is 38 bits (e.g., 2+16+0+20=38 bits).

As shown in FIG. 14, the CSI report 1000 of FIG. 10 may add no additional overhead to the first CSI part, but may have a large increase in additional overhead to the second CSI part, regardless of the number of selected TRPs. The CSI report 1100 of FIG. 11 may have the lowest total overhead with a small number of selected TRPs (e.g., N=1 or 2), but has the largest first CSI part of the three example CSI reports. The CSI report 1200 of FIG. 12 provides a compromise between the other two CSI reports with respect to the first CSI part and has almost the same total overhead as the CSI report 1100 of FIG. 11. Thus, in some aspects, the CSI report 1200 of FIG. 12 may be a preferred implementation of the CSI report.

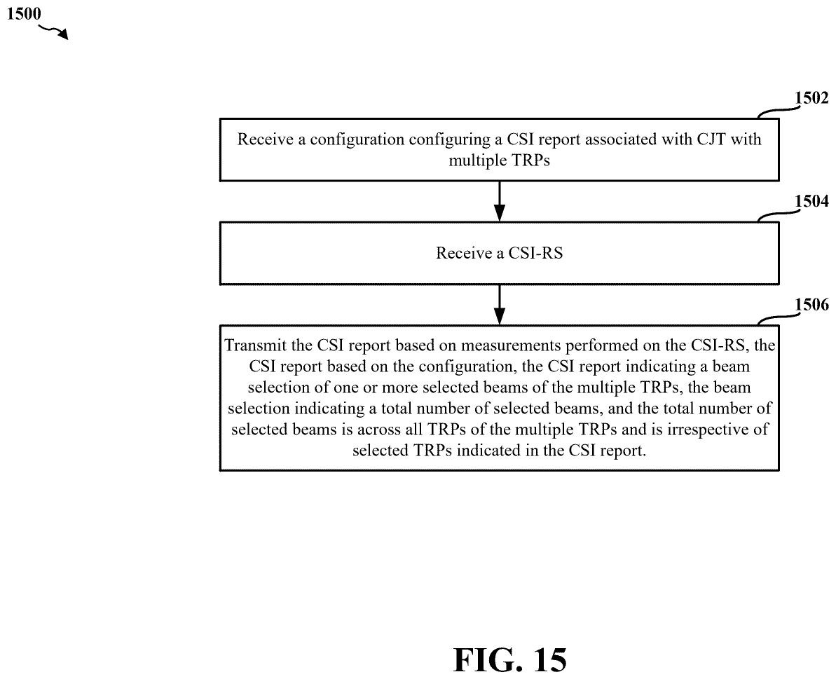

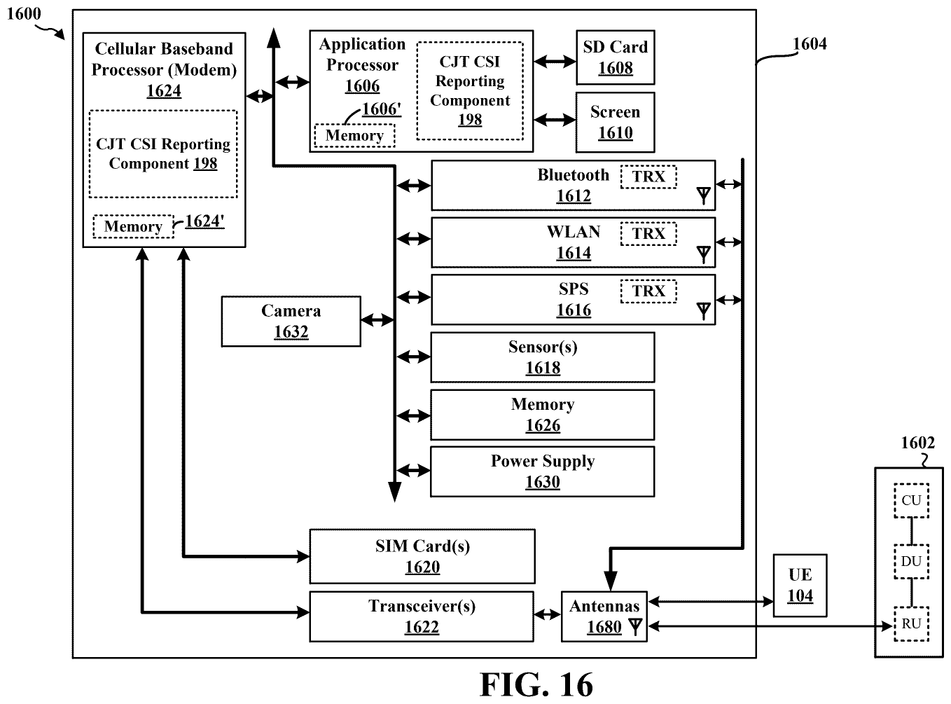

FIG. 15 is a flowchart 1500 of a method of wireless communication. The method may be performed by a UE (e.g., the UE 104, and/or an apparatus 1604 of FIG. 16). The method may facilitate reducing overhead associated with CSI by exploiting indication redundancy between TRP selection and SD basis selection.

At 1502, the UE receives a configuration configuring a CSI report associated with CJT with multiple TRPs, as described in connection with the CJT CSI configuration 910 of FIG. 9. The receiving of the configuration, at 1502, may be performed, for example, by the CJT CSI reporting component 98 of the apparatus 1604, a cellular RF transceiver 1622, and/or one or more antennas 1680 in FIG. 16, as an example.

At 1504, the UE receives a CSI-RS, as described in connection with the CSI-RS 920 of FIG. 9. The receiving of the CSI-RS, at 1504, may be performed, for example, by the CJT CSI reporting component 198 of the apparatus 1604, the cellular RF transceiver 1622, and/or the one or more antennas 1680 in FIG. 16, as an example.

At 1506, the UE transmits a CSI report based on measurements performed on the CSI-RS, the CSI report based on the configuration, the CSI report indicating a beam selection of one or more selected beams of the multiple TRPs, the beam selection indicating a total number of selected beams, and the total number of selected beams is across all TRPs of the multiple TRPs and is irrespective of selected TRPs indicated in the CSI report, as described in connection with the CSI report 950 of FIG. 9. The beam selection may be common to each layer of communication using the one or more selected beams. The transmitting of the CSI report, at 1506 may be performed, for example, by the CJT CSI reporting component 198 of the apparatus 1604, the cellular RF transceiver 1622, and/or the one or more antennas 1680 in FIG. 16, as an example.

In some examples, the UE may receive data in a CJT, as described in connection with the CJT data 970 of FIG. 9. The CJT may be at least partly based on the CSI report.

The CSI report may include a first CSI part and a second CSI part, as described in connection with the first CSI part 952 and the second CSI part 954 of FIG. 9. The first CSI part may have a fixed payload size, and the second CSI part may have a variable payload size indicated in the first CSI part.

In some examples, the second CSI part may include an indication of the beam selection via a SD basis selection field, as described in connection with the CSI report 1000 of FIG. 10. The SD basis selection field may include a first portion indicating a number of oversampling beam groups for each TRP of the multiple TRPs and a second portion indicating the one or more selected beams of the beam selection, as described in connection with the first parameter 1034 and the second parameter 1036, respectively, of FIG. 10.

In some examples, the first portion may be associated with a first bit width based on a maximum number of TRPs of the multiple TRPs available for the CJT (N_{TRP}) and a quantity of oversampling beam groups (O₁O₂). In some examples, the second portion may be associated with a second bit width based on the maximum number of TRPs of the multiple TRPs available for the CJT (N_{TRP}), a number of beams for each TRP (N₁N₂), and the total number of selected beams (L).

In some examples, the first CSI part of the CSI report may include a first indication of one or more selected TRPs of the multiple TRPs, the first indication indicating a number of selected TRPs (N) of the multiple TRPs, as described in connection with the CSI report 1100 of FIG. 11. In some examples, the first indication of the one or more selected TRPs may include one of: a bitmap indication of a maximum number of TRPs of the multiple TRPs available for the CJT (N_{TRP}), a number of configured combinations of TRPs of the multiple TRPs, or a CSI resource indicator (CRI) that indicates the one or more selected TRPs. In some examples, the second CSI part of the CSI report (e.g., the second CSI part 1130 of FIG. 11) may include an indication of the beam selection via a SD basis selection field, the SD basis selection field including a first portion indicating a number of oversampling beam groups for each of the one or more selected TRPs, and a second portion indicating the one or more selected beams of the beam selection, as described in connection with the first parameter 1134 and the second parameter 1136, respectively, of FIG. 11. In some examples, the first portion may be associated with a first bit width based on the number of selected TRPs (N) and a quantity of oversampling beam groups (O₁O₂). In some examples, the second portion may be associated with a second bit width based on the number of selected TRPs (N), a number of beams for each TRP (N₁N₂), and the total number of selected beams (L). In some examples, the CSI report includes a first indication of a number of selected TRPs (N) of the multiple TRPs and a second indication indicating a selected number of SD bases (Lₙ) for each TRP of the number of selected TRPs (N).

In some examples, the first CSI part may include a first indication indicating a number of selected TRPs (N) based on one or more selected TRPs of the multiple TRPs, as described in connection with the CSI report 1200 of FIG. 12. In some examples, the first indication is with a bit width based on a maximum number of TRPs of the multiple TRPs available for the CJT (N_{TRP}). In some examples, the second CSI part may include an indication of the beam selection via a SD basis selection field, the SD basis selection field including a first portion indicating a number of oversampling beam groups for each of the one or more selected TRPs, a second portion indicating the one or more selected TRPs of the multiple TRPs, and a third portion indicating the one or more selected beams of the beam selection, as described in connection with the first parameter 1234, the second parameter 1236, and the third parameter 1238 of FIG. 12. In some examples, the first portion may be associated with a second bit width based on the number of selected TRPs (N) and a quantity of oversampling beam groups (O₁O₂). In some examples, the second portion may be associated with a third bit width based on at least one of: a maximum number of TRPs of the multiple TRPs available for the CJT (N_{TRP}) and the number of selected TRPs (N), or a number of configured combinations of TRPs of the multiple TRPs and the number of selected TRPs (N). In some examples, the third portion may be associated with a fourth bit width based on the number of selected TRPs (N), a number of beams for each TRP (N₁N₂), and the total number of selected beams (L).

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers (e.g., a cellular RF transceiver 1622). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize one or more antennas 1680 for communication. The cellular baseband processor 1624 communicates through transceiver(s) (e.g., the cellular RF transceiver 1622) via one or more antennas 1680 with the UE 104 and/or with an RU associated with a network entity 1602. The cellular baseband processor 1624 and the application processor 1606 may each include a computer-readable medium/memory, such as the on-chip memory 1624′, and the on-chip memory 1606′, respectively. The additional memory modules 1626 may also be considered a computer-readable medium/memory. Each computer-readable medium/memory (e.g., the on-chip memory 1624′, the on-chip memory 1606′, and/or the additional memory modules 1626) may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the TX processor 368, the RX processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see the UE 350 of FIG. 3) and include the additional modules of the apparatus 1604.

As discussed supra, the CJT CSI reporting component 198 may be configured to: receive a configuration configuring a CSI report associated with CJT with multiple TRPs; receive a CSI-RS; and transmit the CSI report based on measurements performed on the CSI-RS, the CSI report based on the configuration, the CSI report indicating a beam selection of one or more selected beams of the multiple TRPs, the beam selection indicating a total number of selected beams, and the total number of selected beams is across all TRPs of the multiple TRPs and is irrespective of selected TRPs indicated in the CSI report.

The CJT CSI reporting component 198 may be within the cellular baseband processor 1624, the application processor 1606, or both the cellular baseband processor 1624 and the application processor 1606. The CJT CSI reporting component 198 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 1604 may include a variety of components configured for various functions. For example, the CJT CSI reporting component 198 may include one or more hardware components that perform each of the blocks of the algorithm in the flowchart of FIG. 15.

In one configuration, the apparatus 1604, and in particular the cellular baseband processor 1624 and/or the application processor 1606, may include means for receiving a configuration configuring a CSI report associated with CJT with multiple TRPs. The example apparatus 1604 also includes means for receiving a CSI-RS. The example apparatus 1604 also includes means for transmitting the CSI report based on measurements performed on the CSI-RS, the CSI report based on the configuration, the CSI report indicating a beam selection of one or more selected beams of the multiple TRPs, the beam selection indicating a total number of selected beams, and the total number of selected beams is across all TRPs of the multiple TRPs and is irrespective of selected TRPs indicated in the CSI report.

In another configuration, the example apparatus 1604 also includes means for receiving data in a CJT.

The means may be the CJT CSI reporting component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

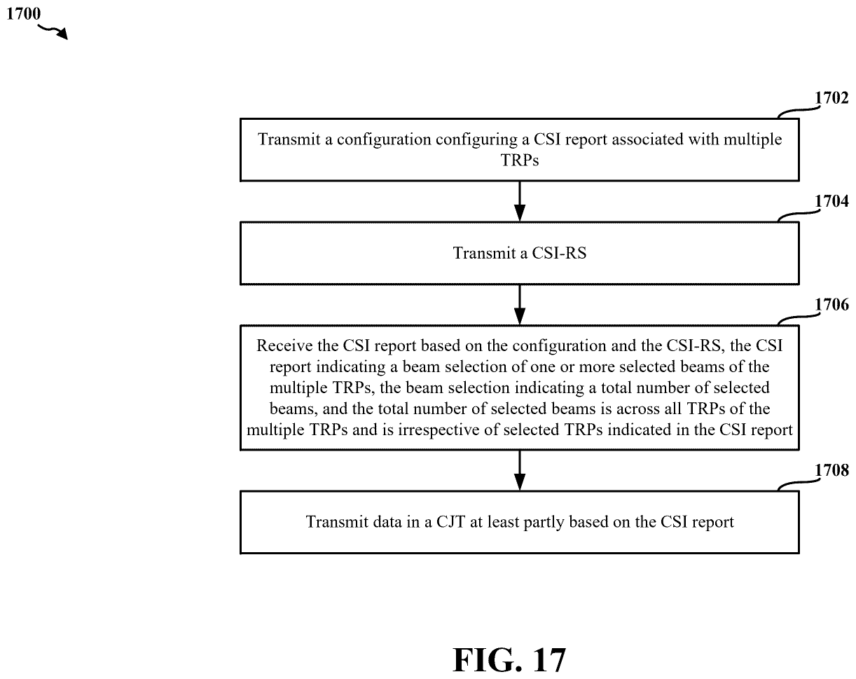

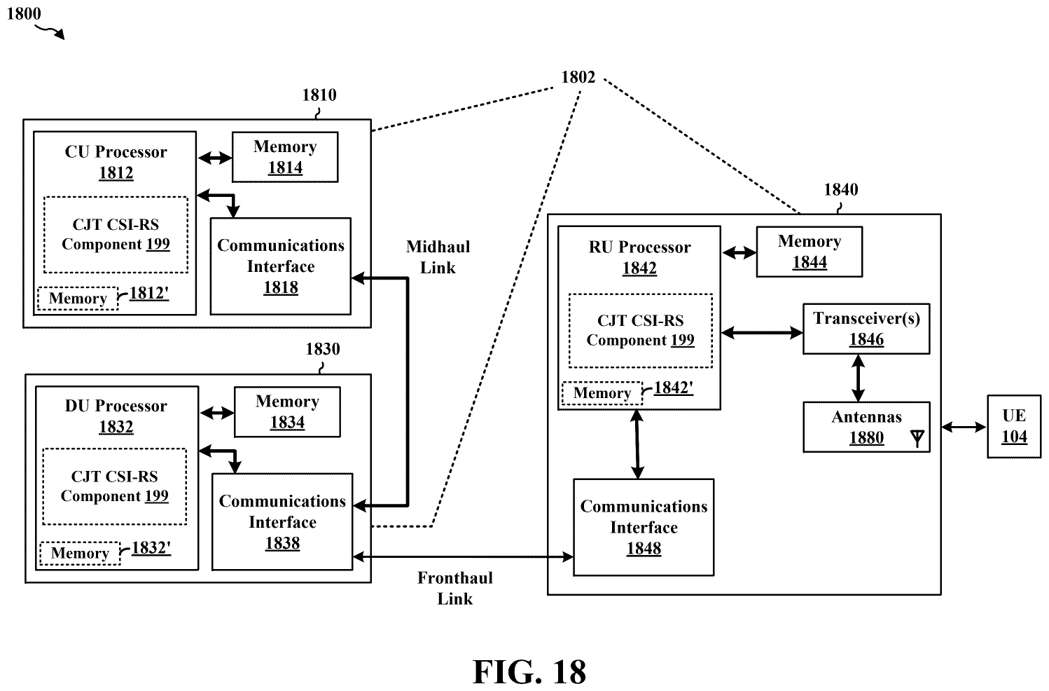

FIG. 17 is a flowchart 1700 of a method of wireless communication. The method may be performed by a network node (e.g., the base station 102, and/or a network entity 1802 of FIG. 18). The method may facilitate reducing overhead associated with CSI by exploiting indication redundancy between TRP selection and SD basis selection.

At 1702, the network node transmits a configuration configuring a CSI report associated with multiple TRPs, as described in connection with the CJT CSI configuration 910 of FIG. 9. The transmitting of the configuration, at 1702, may be performed by the CJT CSI-RS component 199 of the network entity 1802 of FIG. 18, as an example.

At 1704, the network node transmits a CSI-RS, as described in connection with the CSI-RS 920 of FIG. 9. The transmitting of the CSI-RS, at 1704, may be performed by the CJT CSI-RS component 199 of the network entity 1802 of FIG. 18, as an example.

At 1706, the network node receives the CSI report based on the configuration and the CSI-RS, the CSI report indicating a beam selection of one or more selected beams of the multiple TRPs, the beam selection indicating a total number of selected beams, and the total number of selected beams is across all TRPs of the multiple TRPs and is irrespective of selected TRPs indicated in the CSI report, as described in connection with the CSI report 950 of FIG. 9. In some examples, the beam selection may be common to each layer of communication using the one or more selected beams. The receiving of the CSI report, at 1706, may be performed by the CJT CSI-RS component 199 of the network entity 1802 of FIG. 18, as an example.

At 1708, the network node transmits data in a CJT at least partly based on the CSI report, as described in connection with the CJT data 970 of FIG. 9. The transmitting of the data, at 1708, may be performed by the CJT CSI-RS component 199 of the network entity 1802 of FIG. 18, as an example.

In some examples, the configuration may configure the CSI report to include a first CSI part and a second CSI part, the first CSI part having a fixed payload size, and the second CSI part having a variable payload size indicated in the first CSI part.

In some examples, the second CSI part may include an indication of the beam selection via a SD basis selection field, the SD basis selection field including a first portion indicating a number of oversampling beam groups for each TRP of the multiple TRPs and a second portion indicating the one or more selected beams of the beam selection, as described in connection with the CSI report 1000 of FIG. 10.

In some examples, the first CSI part may include a first indication of one or more selected TRPs of the multiple TRPs, the first indication indicating a number of selected TRPs (N) of the multiple TRPs, and the second CSI part includes an indication of the beam selection via a SD basis selection field, the SD basis selection field including a first portion indicating a number of oversampling beam groups for each of the one or more selected TRPs, and a second portion indicating the one or more selected beams of the beam selection, as described in connection with the CSI report 1100 of FIG. 11.

In some examples, the first CSI part may include a first indication indicating a number of selected TRPs (N) based on one or more selected TRPs of the multiple TRPs, and the second CSI part includes an indication of the beam selection via a SD basis selection field, the SD basis selection field including a first portion indicating a number of oversampling beam groups for each of the one or more selected TRPs, a second portion indicating the one or more selected TRPs of the multiple TRPs, and a third portion indicating the one or more selected beams of the beam selection, as described in connection with the CSI report 1200 of FIG. 12.

In some examples, the first CSI part includes a first indication of one or more selected TRPs of the multiple TRPs, the first indication indicating a number of selected TRPs (N) of the multiple TRPs. In some examples, the first indication of the one or more selected TRPs includes a bitmap indication of a maximum number of TRPs of the multiple TRPs available for the CJT (N_{TRP}). In some examples, the second CSI part includes an indication of the beam selection via a SD basis selection field, the SD basis selection field including a first portion indicating a number of oversampling beam groups for each of the one or more selected TRPs, and a second portion indicating the one or more selected beams of the beam selection. In some examples, the first portion is associated with a first bit width based on the number of selected TRPs (N) and a quantity of oversampling beam groups (O₁O₂). In some examples, the second portion is associated with a second bit width based on the number of selected TRPs (N), a number of beams for each TRP (N₁N₂), and the total number of selected beams (L). In some examples, the CSI report includes a first indication of a number of selected TRPs (N) of the multiple TRPs and a second indication indicating a selected number of SD bases (Lₙ) for each TRP of the number of selected TRPs (N).

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the CJT CSI-RS component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memories (e.g., the on-chip memory 1812′, the on-chip memory 1832′, and/or the on-chip memory 1842′) and/or the additional memory modules (e.g., the additional memory modules 1814, the additional memory modules 1834, and/or the additional memory modules 1844) may each be considered a computer-readable medium/memory. Each computer-readable medium/memory may be non-transitory. Each of the CU processor 1812, the DU processor 1832, the RU processor 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the CJT CSI-RS component 199 may be configured to: transmit a configuration configuring a CSI report associated with multiple TRPs; transmit a CSI-RS; receive the CSI report based on the configuration and the CSI-RS, the CSI report indicating a beam selection of one or more selected beams of the multiple TRPs, the beam selection indicating a total number of selected beams, and the total number of selected beams is across all TRPs of the multiple TRPs and is irrespective of selected TRPs indicated in the CSI report; and transmit data in a CJT at least partly based on the CSI report.

The CJT CSI-RS component 199 may be within one or more processors of one or more of the CU 1810, DU 1830, and the RU 1840. The CJT CSI-RS component 199 may be one or more hardware components specifically configured to carry out the stated processes/algorithm, implemented by one or more processors configured to perform the stated processes/algorithm, stored within a computer-readable medium for implementation by one or more processors, or some combination thereof.

The network entity 1802 may include a variety of components configured for various functions. For example, the CJT CSI-RS component 199 may include one or more hardware components that perform each of the blocks of the algorithm in the flowcharts of FIG. 17.

In one configuration, the network entity 1802 may include means for transmitting a configuration configuring a CSI report associated with multiple TRPs. The example network entity 1802 also includes means for transmitting a CSI-RS. The example network entity 1802 also includes means for receiving the CSI report based on the configuration and the CSI-RS, the CSI report indicating a beam selection of one or more selected beams of the multiple TRPs, the beam selection indicating a total number of selected beams, and the total number of selected beams is across all TRPs of the multiple TRPs and is irrespective of selected TRPs indicated in the CSI report. The example network entity 1802 also includes means for transmitting data in a CJT at least partly based on the CSI report.

The means may be the CJT CSI-RS component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

In some aspects of wireless communication, joint transmission across multiple TRPs may be enabled. The joint transmission may be a non-coherent JT (NCJT) in which data (layers) may be precoded separately on different TRPs, or may be a CJT in which a same layer may be transmitted via multiple TRPs with phase coherence.

Aspects disclosed herein provide techniques for utilizing the relationship between TRP selection and SD basis selection to improve communication performance, for example, by reducing overhead associated with indicating the TRP selection and the SD basis selection. In some examples, the number of selected SD bases (e.g., L beams) may be configured to the UE and may represent the total number of selected SD bases across all TRPs, and may be independent of the N TRPs indicated in the CSI report.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: receiving a configuration configuring a CSI report associated with CJT with multiple TRPs; receiving a CSI-RS; and transmitting the CSI report based on measurements performed on the CSI-RS, the CSI report based on the configuration, the CSI report indicating a beam selection of one or more selected beams of the multiple TRPs, the beam selection indicating a total number of selected beams, and the total number of selected beams is across all TRPs of the multiple TRPs and is irrespective of selected TRPs indicated in the CSI report.

Aspect 2 is the method of aspect 1, further including that the CSI report includes a first CSI part and a second CSI part, the first CSI part having a fixed payload size, and the second CSI part having a variable payload size indicated in the first CSI part.

Aspect 3 is the method of any of aspects 1 and 2, further including that the first CSI part includes a first indication of one or more selected TRPs of the multiple TRPs, the first indication indicating a number of selected TRPs (N) of the multiple TRPs.

Aspect 4 is the method of any of aspects 1 to 3, further including that the first indication of the one or more selected TRPs includes a bitmap indication of a maximum number of TRPs of the multiple TRPs available for the CJT (N_{TRP}).

Aspect 5 is the method of any of aspects 1 to 4, further including that the second CSI part includes an indication of the beam selection via a SD basis selection field, the SD basis selection field including a first portion indicating a number of oversampling beam groups for each of the one or more selected TRPs, and a second portion indicating the one or more selected beams of the beam selection.

Aspect 6 is the method of any of aspects 1 to 5, further including that the first portion is associated with a first bit width based on the number of selected TRPs (N) and a quantity of oversampling beam groups (O₁O₂).

Aspect 7 is the method of any of aspects 1 to 6, further including that the second portion is associated with a second bit width based on the number of selected TRPs (N), a number of beams for each TRP (N₁N₂), and the total number of selected beams (L).

Aspect 8 is the method of any of aspects 1 to 7, further including that the CSI report includes a first indication of a number of selected TRPs (N) of the multiple TRPs and a second indication indicating a selected number of SD bases (Lₙ) for each TRP of the number of selected TRPs (N).

Aspect 9 is the method of any of aspects 1 and 2, further including that the first CSI part includes a first indication indicating a number of selected TRPs (N) based on one or more selected TRPs of the multiple TRPs.

Aspect 10 is the method of any of aspects 1 and 9, further including that the first indication is with a bit width based on a maximum number of TRPs of the multiple TRPs available for the CJT (N_{TRP}).

Aspect 11 is the method of any of aspects 1 and 9 to 10, further including that the second CSI part includes an indication of the beam selection via a SD basis selection field, the SD basis selection field including a first portion indicating a number of oversampling beam groups for each of the one or more selected TRPs, a second portion indicating the one or more selected TRPs of the multiple TRPs, and a third portion indicating the one or more selected beams of the beam selection.

Aspect 12 is the method of any of aspects 1 and 9 to 11, further including that the first portion is associated with a second bit width based on the number of selected TRPs (N) and a quantity of oversampling beam groups (O₁O₂).

Aspect 13 is the method of any of aspects 1 and 9 to 12, further including that the second portion is associated with a third bit width based on at least one of: a maximum number of TRPs of the multiple TRPs available for the CJT (N_{TRP}) and the number of selected TRPs (N), or a number of configured combinations of the TRPs of the multiple TRPs and the number of selected TRPs (N).

Aspect 14 is the method of any of aspects 1 and 9 to 13, further including that the third portion is associated with a fourth bit width based on the number of selected TRPs (N), a number of beams for each TRP (N₁N₂), and the total number of selected beams (L).

Aspect 15 is the method of any of aspects 1 and 2, further including that the second CSI part includes an indication of the beam selection via a SD basis selection field, the SD basis selection field including a first portion indicating a number of oversampling beam groups for each TRP of the multiple TRPs and a second portion indicating the one or more selected beams of the beam selection.

Aspect 16 is the method of any of aspects 1 and 14 to 15, further including that the first portion is associated with a first bit width based on a maximum number of TRPs of the multiple TRPs available for the CJT (N_{TRP}) and a quantity of oversampling beam groups (O₁O₂).

Aspect 17 is the method of any of aspects 1 and 14 to 16, further including that the second portion is associated with a second bit width based on the maximum number of TRPs of the multiple TRPs available for the CJT (N_{TRP}), a number of beams for each TRP (N₁N₂), and the total number of selected beams (L).

Aspect 18 is the method of any of aspects 1 and 14 to 17, further including that the beam selection is common to each layer of communication using the one or more selected beams.

Aspect 19 is an apparatus for wireless communication at a UE including at least one processor coupled to a memory and configured to implement any of aspects 1 to 18.

In aspect 20, the apparatus of aspect 19 further includes at least one antenna coupled to the at least one processor.

In aspect 21, the apparatus of aspect 19 or 20 further includes a transceiver coupled to the at least one processor.

Aspect 22 is an apparatus for wireless communication including means for implementing any of aspects 1 to 18.

In aspect 23, the apparatus of aspect 22 further includes at least one antenna coupled to the means to perform the method of any of aspects 1 to 18.

In aspect 24, the apparatus of aspect 22 or 23 further includes a transceiver coupled to the means to perform the method of any of aspects 1 to 18.

Aspect 25 is a non-transitory computer-readable storage medium storing computer executable code, where the code, when executed, causes a processor to implement any of aspects 1 to 18.

Aspect 26 is a method of wireless communication at a network entity, including: transmitting a configuration configuring a CSI report associated with multiple TRPs; transmitting a CSI-RS; receiving the CSI report based on the configuration and the CSI-RS, the CSI report indicating a beam selection of one or more selected beams of the multiple TRPs, the beam selection indicating a total number of selected beams, and the total number of selected beams is across all TRPs of the multiple TRPs and is irrespective of selected TRPs indicated in the CSI report; and transmitting data in a coherent joint transmission (CJT) at least partly based on the CSI report.

Aspect 27 is the method of aspect 26, further including that the configuration configures the CSI report to include a first CSI part and a second CSI part, the first CSI part having a fixed payload size, and the second CSI part having a variable payload size indicated in the first CSI part.

Aspect 28 is the method of any of aspects 26 and 27, further including that the first CSI part includes a first indication of one or more selected TRPs of the multiple TRPs, the first indication indicating a number of selected TRPs (N) of the multiple TRPs.

Aspect 29 is the method of any of aspects 26 to 28, further including that the first indication of the one or more selected TRPs includes a bitmap indication of a maximum number of TRPs of the multiple TRPs available for the CJT (N_{TRP}).

Aspect 30 is the method of any of aspects 26 to 29, further including that the second CSI part includes an indication of the beam selection via a SD basis selection field, the SD basis selection field including a first portion indicating a number of oversampling beam groups for each of the one or more selected TRPs, and a second portion indicating the one or more selected beams of the beam selection.

Aspect 31 is the method of any of aspects 26 to 30, further including that the first portion is associated with a first bit width based on the number of selected TRPs (N) and a quantity of oversampling beam groups (O₁O₂).

Aspect 32 is the method of any of aspects 26 to 31, further including that the second portion is associated with a second bit width based on the number of selected TRPs (N), a number of beams for each TRP (N₁N₂), and the total number of selected beams (L).

Aspect 33 is the method of any of aspects 26 and 27, further including that the CSI report includes a first indication of a number of selected TRPs (N) of the multiple TRPs and a second indication indicating a selected number of SD bases (Lₙ) for each TRP of the number of selected TRPs (N).

Aspect 34 is the method of any of aspects 26 and 27, further including that the second CSI part includes an indication of the beam selection via a SD basis selection field, the SD basis selection field including a first portion indicating a number of oversampling beam groups for each TRP of the multiple TRPs and a second portion indicating the one or more selected beams of the beam selection.

Aspect 35 is the method of any of aspects 26 and 27, further including that the first CSI part includes a first indication of one or more selected TRPs of the multiple TRPs, the first indication indicating a number of selected TRPs (N) of the multiple TRPs, and the second CSI part includes an indication of the beam selection via a SD basis selection field, the SD basis selection field including a first portion indicating a number of oversampling beam groups for each of the one or more selected TRPs, and a second portion indicating the one or more selected beams of the beam selection.

Aspect 36 is the method of any of aspects 26 and 27, further including that the first CSI part includes a first indication indicating a number of selected TRPs (N) based on one or more selected TRPs of the multiple TRPs, and the second CSI part includes an indication of the beam selection via a SD basis selection field, the SD basis selection field including a first portion indicating a number of oversampling beam groups for each of the one or more selected TRPs, a second portion indicating the one or more selected TRPs of the multiple TRPs, and a third portion indicating the one or more selected beams of the beam selection.

Aspect 37 is the method of any of aspects 26 to 36, further including that the beam selection is common to each layer of communication using the one or more selected beams.

Aspect 38 is an apparatus for wireless communication at a network entity including at least one processor coupled to a memory and configured to implement any of aspects 26 to 37.

In aspect 39, the apparatus of aspect 38 further includes at least one antenna coupled to the at least one processor.

In aspect 40, the apparatus of aspect 38 or 39 further includes a transceiver coupled to the at least one processor.

Aspect 41 is an apparatus for wireless communication including means for implementing any of aspects 26 to 37.

In aspect 42, the apparatus of aspect 41 further includes at least one antenna coupled to the means to perform the method of any of aspects 26 to 37.

In aspect 43, the apparatus of aspect 41 or 42 further includes a transceiver coupled to the means to perform the method of any of aspects 26 to 37.

Aspect 44 is a non-transitory computer-readable storage medium storing computer executable code, where the code, when executed, causes a processor to implement any of aspects 26 to 37.

What is claimed is:

1. An apparatus for wireless communication at a user equipment (UE), comprising:
memory; and
at least one processor coupled to the memory and configured to:
receive a configuration configuring a channel state information (CSI) report associated with coherent joint transmission (CJT) with multiple transmission reception points (TRPs);
receive a CSI reference signal (CSI-RS); and
transmit the CSI report based on measurements performed on the CSI-RS, the CSI report based on the configuration, the CSI report indicating a beam selection of one or more selected beams of the multiple TRPs, the beam selection indicating a total number of selected beams, and the total number of selected beams is across all TRPs of the multiple TRPs and is irrespective of selected TRPs indicated in the CSI report.

2. The apparatus of claim 1, wherein the CSI report includes a first CSI part and a second CSI part, the first CSI part having a fixed payload size, and the second CSI part having a variable payload size indicated in the first CSI part.

3. The apparatus of claim 2, wherein the first CSI part includes a first indication of one or more selected TRPs of the multiple TRPs, the first indication indicating a number of selected TRPs (N) of the multiple TRPs.

4. The apparatus of claim 3, wherein the first indication of the one or more selected TRPs includes a bitmap indication of a maximum number of TRPs of the multiple TRPs available for the CJT (N_{TRP}).

5. The apparatus of claim 3, wherein the second CSI part includes an indication of the beam selection via a spatial domain (SD) basis selection field, the SD basis selection field including a first portion indicating a number of oversampling beam groups for each of the one or more selected TRPs, and a second portion indicating the one or more selected beams of the beam selection.

6. The apparatus of claim 5, wherein the first portion is associated with a first bit width based on the number of selected TRPs (N) and a quantity of oversampling beam groups (O₁O₂).

7. The apparatus of claim 6, wherein the second portion is associated with a second bit width based on the number of selected TRPs (N), a number of beams for each TRP (N₁N₂), and the total number of selected beams (L).

8. The apparatus of claim 2, wherein the CSI report includes a first indication of a number of selected TRPs (N) of the multiple TRPs and a second indication indicating a selected number of SD bases (Lₙ) for each TRP of the number of selected TRPs (N).

9. The apparatus of claim 2, wherein the first CSI part includes a first indication indicating a number of selected TRPs (N) based on one or more selected TRPs of the multiple TRPs.

10. The apparatus of claim 9, wherein the first indication is with a bit width based on a maximum number of TRPs of the multiple TRPs available for the CJT (N_{TRP}).

11. The apparatus of claim 9, wherein the second CSI part includes an indication of the beam selection via a spatial domain (SD) basis selection field, the SD basis selection field including a first portion indicating a number of oversampling beam groups for each of the one or more selected TRPs, a second portion indicating the one or more selected TRPs of the multiple TRPs, and a third portion indicating the one or more selected beams of the beam selection.

12. The apparatus of claim 11, wherein the first portion is associated with a second bit width based on the number of selected TRPs (N) and a quantity of oversampling beam groups (O₁O₂).

13. The apparatus of claim 12, wherein the second portion is associated with a third bit width based on at least one of:
a maximum number of TRPs of the multiple TRPs available for the CJT (N_{TRP}) and the number of selected TRPs (N), or
a number of configured combinations of the TRPs of the multiple TRPs and the number of selected TRPs (N).

14. The apparatus of claim 13, wherein the third portion is associated with a fourth bit width based on the number of selected TRPs (N), a number of beams for each TRP (N₁N₂), and the total number of selected beams (L).

15. The apparatus of claim 2, wherein the second CSI part includes an indication of the beam selection via a spatial domain (SD) basis selection field, the SD basis selection field including a first portion indicating a number of oversampling beam groups for each TRP of the multiple TRPs and a second portion indicating the one or more selected beams of the beam selection.

16. The apparatus of claim 15, wherein the first portion is associated with a first bit width based on a maximum number of TRPs of the multiple TRPs available for the CJT (N_{TRP}) and a quantity of oversampling beam groups (O₁O₂).

17. The apparatus of claim 16, wherein the second portion is associated with a second bit width based on the maximum number of TRPs of the multiple TRPs available for the CJT (N_{TRP}), a number of beams for each TRP (N₁N₂), and the total number of selected beams (L).

18. The apparatus of claim 1, wherein the beam selection is common to each layer of communication using the one or more selected beams.

19. The apparatus of claim 1, further comprising:
at least one transceiver or at least one antenna coupled to the at least one processor and configured to transmit the CSI report.

20. A method of wireless communication at a user equipment (UE), comprising:
receiving a configuration configuring a channel state information (CSI) report associated with coherent joint transmission (CJT) with multiple transmission reception points (TRPs);
receiving a CSI reference signal (CSI-RS); and
transmitting the CSI report based on measurements performed on the CSI-RS, the CSI report based on the configuration, the CSI report indicating a beam selection of one or more selected beams of the multiple TRPs, the beam selection indicating a total number of selected beams, and the total number of selected beams is across all TRPs of the multiple TRPs and is irrespective of selected TRPs indicated in the CSI report.

21. An apparatus for wireless communication, comprising:
memory; and
at least one processor coupled to the memory and configured to:
transmit a configuration configuring a channel state information (CSI) report associated with multiple transmission reception points (TRPs);
transmit a CSI reference signal (CSI-RS);
receive the CSI report based on the configuration and the CSI-RS, the CSI report indicating a beam selection of one or more selected beams of the multiple TRPs, the beam selection indicating a total number of selected beams, and the total number of selected beams is across all TRPs of the multiple TRPs and is irrespective of selected TRPs indicated in the CSI report; and
transmit data in a coherent joint transmission (CJT) at least partly based on the CSI report.

22. The apparatus of claim 21, wherein the configuration configures the CSI report to include a first CSI part and a second CSI part, the first CSI part having a fixed payload size, and the second CSI part having a variable payload size indicated in the first CSI part.

23. The apparatus of claim 22, wherein the first CSI part includes a first indication of one or more selected TRPs of the multiple TRPs, the first indication indicating a number of selected TRPs (N) of the multiple TRPs.

24. The apparatus of claim 23, wherein the first indication of the one or more selected TRPs includes a bitmap indication of a maximum number of TRPs of the multiple TRPs available for the CJT (N_{TRP}).

25. The apparatus of claim 23, wherein the second CSI part includes an indication of the beam selection via a spatial domain (SD) basis selection field, the SD basis selection field including a first portion indicating a number of oversampling beam groups for each of the one or more selected TRPs, and a second portion indicating the one or more selected beams of the beam selection.

26. The apparatus of claim 25, wherein the first portion is associated with a first bit width based on the number of selected TRPs (N) and a quantity of oversampling beam groups (O₁O₂).

27. The apparatus of claim 26, wherein the second portion is associated with a second bit width based on the number of selected TRPs (N), a number of beams for each TRP (N₁N₂), and the total number of selected beams (L).

28. The apparatus of claim 22, wherein the CSI report includes a first indication of a number of selected TRPs (N) of the multiple TRPs and a second indication indicating a selected number of SD bases (Lₙ) for each TRP of the number of selected TRPs (N).

29. The apparatus of claim 21, further comprising:
at least one transceiver or at least one antenna coupled to the at least one processor and configured to receive the CSI report.

30. A method of wireless communication, comprising:
transmitting a configuration configuring a channel state information (CSI) report associated with multiple transmission reception points (TRPs);
transmitting a CSI reference signal (CSI-RS);
receiving the CSI report based on the configuration and the CSI-RS, the CSI report indicating a beam selection of one or more selected beams of the multiple TRPs, the beam selection indicating a total number of selected beams, and the total number of selected beams is across all TRPs of the multiple TRPs and is irrespective of selected TRPs indicated in the CSI report; and
transmitting data in a coherent joint transmission (CJT) at least partly based on the CSI report.
